(19) United States
(12) Patent Application Publication
(10) Pub. No.: US 2008/0023525 A1
(43) Pub. Date: Jan. 31, 2008

(54) Bonding apparatus

(75) Inventors: Toru Maeda, Tachikawa-shi (JP); Kazuo Fujita, Musashimurayama-shi (JP)

Correspondence Address: QUINN EMANUEL;KODA & ANDROLIA, 865 S. FIGUEROA STREET, 10TH FLOOR, LOS ANGELES, CA, 90017, US

(73) Assignee: Kabushiki Kaisha Shinkawa

(21) Appl. No.: 11/888,155

(22) Filed: Jul. 31, 2007

(30) Foreign Application Priority Data
Jul. 31, 2006 (JP) 2006-208710

(51) Int. Cl. B23K 1/20

(52) U.S. Cl. 228/18

(57) ABSTRACT

A bonding apparatus capable of efficiently performing surface treatment using microplasma and a bonding process to an object to be bonded including a plasma capillary having a tubular plasma capillary main body made of an insulating body, a cylindrical external electrode provided outside the tubular plasma capillary main body, a linear internal electrode provided at the center of the inside of the tubular plasma capillary main body, and a seal gas nozzle provided at the outer circumference of the tubular plasma capillary main body. Microplasma produced within the plasma capillary is sprayed from the main body opening, and performs the surface treatment to a bonding pad while being sealed from an ambient air by a seal gas flow sprayed from the annular opening. In conjunction with the surface treatment, bonding is performed using a bonding capillary.

### BACKGROUND OF THE INVENTION

The present invention relates to bonding apparatuses, and, in particular, to a bonding apparatus capable of bonding after performing surface treatment to an object to be bonded.

A wire bonding apparatus that connects an electrode portion of a semiconductor chip to a lead terminal of a circuit board with a thin metallic wire has been known. The importance of a surface condition of the electrode portion of the semiconductor chip and the lead terminal of the circuit board, to which the thin metallic wire is bonded and which are often referred to as a bonding pad and a bonding lead, respectively, is acknowledged in bonding the thin metallic wire to the bonding pad and the bonding lead using, for example, a ultrasonic bonding technique or a thermocompression bonding technique. Specifically, if the surface of a metal layer of the bonding pad or of the bonding lead is contaminated or attached with foreign substances, a desirable electrical junction between the surface and the thin metallic wire cannot be achieved, and a mechanical junction therebetween can be weak. Thus, attempts have been made to make precaution against the bonding pad and/or to the bonding lead prior to bonding.

One of such attempts is to perform a surface treatment to the bonding pad or to the bonding lead prior to the bonding process.

For example, Japanese Patent Application Unexamined Publication Disclosure No. 2000-340599 discloses an apparatus for performing wire bonding after cleaning the surface to be bonded, and it describes a wire bonding apparatus in which a plasma jet unit and a wire bonding unit are integrally provided. The plasma jet unit has a concentrical double structure including an outer dielectric tube and an inner dielectric tube. The outer dielectric tube has a grounded conular electrode, and the inner dielectric tube has therein a rod-shaped high frequency electrode. An atmospheric glow discharge is caused between the outer and inner dielectric tubes after introducing Argon gas, for example, to produce low temperature plasma. The plasma thus produced is sprayed through a gas spray nozzle to the electrode, and as a result the contamination on the electrode is removed, and then the wire bonding is performed.

Further, Japanese Patent Application Unexamined Publication Disclosure No. H11-260597, which is corresponding to U.S. Pat. No. 6,429,400 B1 discloses a plasma treatment apparatus, and a technique of cooling an electrode is described therein as a method for suppressing a streamer discharge in order to perform plasma treatment based on a stable glow discharge. As an example of systems employing such a plasma treatment apparatus, a system capable of performing the surface treatment to a plurality of bonding pads that surround electronic components of an IC mounted circuit board carried with a belt conveyor or such is described. In this technique, the system reads coordinates of each bonding pad on a substrate, controls a position at which plasma jet is sprayed in accordance with the coordinates, and performs the plasma treatment while sequentially transferring the substrate.

Japanese Patent Application Unexamined Publication Disclosure No. 2003-328138 discloses a microplasma chemical vapor deposition (CVD) apparatus, and describes that, in a configuration in which a high frequency coil is provided at a tip portion of a tapered tubular plasma torch made of insulating material and a wire is threaded through the plasma torch, high frequency induction plasma is produced between the wire in the plasma torch and the high frequency coil. It is further described that setting a diameter of the tip portion of the plasma torch to approximately 100 μm enables deposition of material such as carbon to a region on the order of 200 μm in the atmosphere using high density microplasma.

Japanese Patent Application Unexamined Publication Disclosure No. H09-316645 discloses a surface treatment apparatus using plasma and a method for the surface treatment using high velocity and high temperature plasma. In this conventional art, a double tube is coupled to an inlet of a laval nozzle of a plasma producing unit wound by an induction coil, where a plasma producing gas is introduced to an inner tube and a seal gas for sealing between an inner surface of the laval nozzle and plasma that is produced is introduced to an outer tube to protect the inner surface of the laval nozzle. With this configuration, it is possible to prevent impurity particles from entering the plasma gas through the inner surface of the laval nozzle, which can result in the deterioration of quality of the surface treatment.

Regarding the high temperature plasma, Japanese Patent Application Unexamined Publication Disclosure No. H11-291023 discloses a plasma torch that heats molten steel in a tundish by plasma arc. More specifically, in this conventional art, a cathode electrode is provided, and a plasma working gas supply pipe for supplying a plasma working gas is concentrically provided about the cathode electrode and along the outer circumference of the cathode electrode. In addition, a seal gas supply pipe for sealing plasma arc produced by the cathode electrode and the plasma working gas is provided concentrically about the cathode electrode and along the outer circumference of the plasma working gas supply pipe. It is also disclosed that this seal gas reduces the possibility that the electrode wears away due to an exposure to, for example, oxygen in the air.

Another attempt to make precaution prior to bonding is to protect the metal layer of the bonding pad or of the bonding lead in advance.

For example, Japanese Patent Application Unexamined Publication Disclosure No. 2001-15549 discloses a semiconductor device and describes that an electrode pad for connecting a bonding wire of the semiconductor device for which copper or a copper alloy is used as wiring material is configured in a multilayer structure. Specifically, a recess is provided on a semiconductor substrate, and a copper film, an antidiffusion film, and an antioxide film are formed in the recess in the stated order from the bottom. Further, a copper anchor layer that is in contact with a lower side of the copper film is implanted in an insulating film of the semiconductor device. The antidiffusion film is made of an alloy mainly consisting of TiN, and W, and such, and the antioxide film is made of an alloy mainly consisting of Al, Au, Ag, and such. These films are all formed in the recess, and the antidiffusion film and the antioxide film that are deposited at an area other than the recess are removed by Chemical Mechanical Polishing (CMP), thus obtaining an electrode pad as high as the insulating film.

Generally, when performing surface treatment to bonding pads or to bonding leads by irradiating low temperature microplasma thereto, an ambient air, an organic matter in the ambient air surrounding plasma state gas jet flow, and such can be caught in the gas jet flow. This can happen even when the speed of the microplasma is not as high as supersonic velocity. Consequently, if the ambient air or the organic matter is caught in the plasma jet in this manner, the surface of the bonding pad or bonding lead that has gone through the surface treatment can be oxidized again by the microplasma itself as surface treatment means, or the organic matter that has been removed from the surface can be again attached to the surface. This results in a problem in which a desirable electrical junction cannot be achieved between the bonding wire and the bonding pad or between the bonding wire and the bonding lead even with the surface treatment by the microplasma, and a mechanical junction therebetween can be weak.

Japanese Patent Application Unexamined Publication Disclosure No. 2000-340599 and Japanese Patent Application Unexamined Publication Disclosure No. 2003-328138 both disclose performing the surface treatment to the bonding pad or the bonding lead with the low temperature microplasma. However, neither of the above disclose the above noted problem of the ambient air caught in the microplasma re-oxidizing or re-contaminating the surface of an object being treated.

Further, Japanese Patent Application Unexamined Publication Disclosure No. H09-316645 discloses that the seal gas flow is provided between the plasma and the laval nozzle in order to protect the inner surface of the laval nozzle of the plasma producing unit against the high velocity plasma, thereby preventing the plasma from contacting directly with the inner surface of the laval nozzle. However, this conventional art neither discloses nor describes the problem that the surrounding ambient air and the organic matter can be caught in the low-temperature plasma.

Moreover, Japanese Patent Application Unexamined Publication Disclosure No. H11-291023 discloses heated plasma that is activated under a high temperature state at as high as 2,000 degrees Celsius, where supplying the seal gas for sealing plasma arc produced by the plasma working gas to the outer circumference, and reducing the possibility that the electrode wears away due to an exposure to oxygen and such in the air. However, this conventional art does not describe low temperature plasma for the surface treatment.

On the other hand, demands for improved accuracy and speed have been increasing for today's wire bonding apparatuses and such. Positioning of a bonding head that performs the bonding process while holding the wire when moving the bonding head is performed at high accuracy and high speed. Accordingly, in order to perform the surface treatment prior to the bonding process, the needs such as the increased speed that are specific to bonding apparatuses must be taken into account. The conventional art described in Japanese Patent Application Unexamined Publication Disclosure No. H11-260597 and Japanese Patent Application Unexamined Publication Disclosure No. 2003-328138 do not take the relation between the surface treatment and the bonding process into account, and Japanese Patent Application Unexamined Publication Disclosure No. 2000-340599 does not describe any specific example of an integral configuration of the plasma jet unit and the wire bonding unit. Furthermore, Japanese Patent Application Unexamined Publication Disclosure No. 2001-15549 does not state the relation between the surface treatment and the plasma treatment.

As described above, with the conventional bonding apparatuses, it is not possible to effectively perform the surface treatment using microplasma to an object to be bonded. Further, it is not possible to perform the surface treatment to the object to be bonded and the bonding process efficiently.

Here, the surface treatment to the object to be bonded is roughly divided into a removal process and a deposition process. Examples of the removal process include removing of contamination, an oxide film, foreign substances, or such on a surface of the object to be bonded by, for example, reduction and etching to obtain a clean surface. Examples of the deposition process include depositing material with a good bonding property, such as gold that is also used for the bonding wire, for example, onto the surface of the object to be bonded. Both of these processes are performed using the microplasma, and thus, the above-described conventional art have not addressed to the problem of re-oxidation and re-contamination in the removal process and the deposition process. In addition, these conventional art have not addressed to a problem of how a solution for re-oxidation and re-contamination can be combined with the bonding technology.

### BRIEF SUMMARY OF THE INVENTION

An object of the present invention is to provide a bonding apparatus capable of effectively performing surface treatment to an object to be bonded using microplasma.

Further, another object of the present invention is to provide a bonding apparatus capable of efficiently performing the surface treatment and a bonding process to the object to be bonded.

The bonding apparatus according to the present invention includes
a bonding process unit capable of performing a bonding process to an object to be bonded using a bonding tool; and
a plasma capillary that includes a plasma producing unit and a seal gas spraying unit in which the plasma producing unit sprays plasma state gas therein to the object to be bonded from the opening at a tip end thereof, and the seal gas spraying unit sprays a seal gas from the opening at a tip end of an annular channel provided outside of the plasma producing unit concentrically, thereby sealing the plasma state gas from an ambient air.

A bonding apparatus according to the present invention includes
a bonding process unit capable of performing a bonding process to an object to be bonded using a bonding arm having a bonding capillary;
a plasma capillary that includes a plasma producing unit and a seal gas spraying unit in which the plasma producing unit sprays plasma state gas therein to the object to be bonded from the opening at a tip end thereof, and the seal gas spraying unit sprays a seal gas from the opening at a tip end of an annular channel provided outside of the plasma producing unit concentrically, thereby sealing the plasma state gas from an ambient air;
a plasma treatment unit capable of performing surface treatment to the object to be bonded using a plasma arm having a plasma capillary at the tip end of the plasma arm; and
a control unit capable of controlling operations of the bonding arm and the plasma arm in conjunction with each other.

In this configuration, it is preferable that the bonding process unit performs the bonding process to the object to be bonded that is held by a stage for bonding, the plasma treatment unit performs the surface treatment to a different object to be bonded that is held by a stage for surface treatment in which the different object to be bonded is the same type as the object to be bonded subject to the bonding process by the bonding process unit, and the control unit controls to cause the bonding process and the surface treatment to be performed, in conjunction with each other, to corresponding portions of the same type of the objects to be bonded, respectively.

It is further preferable that the plasma producing unit is a capacitatively coupled microplasma producing unit capable of, by power supply to a cylindrical external electrode provided concentrically with a tubular member made of an insulating body and to a linear internal electrode provided along a central axis of the tubular member, spraying the plasma state gas inside the tubular member from an opening at a tip end portion of the tubular member.

Another bonding apparatus according to the present invention includes
a bonding process unit capable of performing a bonding process to an object to be bonded using a bonding tool;
a plasma capillary that includes a plasma producing unit and a seal gas spraying unit in which the plasma producing unit sprays a plasma state gas therein to the object to be bonded from the opening at a tip end thereof, and the seal gas spraying unit sprays a seal gas from the opening at a tip end of an annular channel provided outside of the plasma producing unit concentrically, thereby sealing the plasma state gas from an ambient air;
a position change unit capable of switching a position of the tip end of a thin wire between a removal position and a deposition position with respect to a plasma region where the gas is formed into plasma state gas within the plasma producing unit wherein the thin wire is made of a predetermined material and inserted in the plasma producing unit, the removal position is a position at which the tip end of the thin wire is positioned outside the plasma region and a removal process is performed to a surface of the object to be bonded by the plasma state gas, and the deposition position is a position at which the tip end of the thin wire is positioned inside the plasma region and the material of the thin wire is, along with the plasma state gas, splayed to the object to be bonded and deposited on the surface of the object to be bonded; and
a control unit capable of causing the position change unit to switch the position of the thin wire in the microplasma producing unit to the removal position so that contamination and/or an oxide film is removed from the surface of the object to be bonded, and then causing the position of the thin wire to be switched to the deposition position so that the predetermined material is deposited on the surface of the object to be bonded.

Still another bonding apparatus according to the present invention includes
a bonding process unit capable of performing a bonding process to an object to be bonded using a bonding arm having a bonding capillary;
a plasma capillary that includes a plasma producing unit and a seal gas spraying unit in which the plasma producing unit sprays a plasma state gas therein to the object to be bonded from the opening at a tip end thereof, and the seal gas spraying unit sprays a seal gas from the opening at a tip end of an annular channel provided outside of the plasma producing unit concentrically, thereby sealing the plasma state gas from an ambient air;
a plasma treatment unit capable of performing surface treatment to the object to be bonded using a plasma arm having a plasma capillary at the tip end of the plasma arm;
a position change unit capable of switching a position of the tip end of a thin wire between a removal position and a deposition position with respect to a plasma region where the gas is formed into plasma state gas within the plasma producing unit, wherein the thin wire is made of a predetermined material and inserted in the plasma producing unit, the removal position is a position at which the tip end of the thin wire is positioned outside the plasma region and a removal process is performed to the surface of the object to be bonded by the plasma state gas, and the deposition position is a position at which the tip end of the thin wire is positioned inside the plasma region and the material of the thin wire is, along with the plasma state gas, splayed to the object to be bonded to be deposited on the surface of the object to be bonded; and
a control unit capable of controlling operations of the bonding arm and the plasma arm in conjunction,

wherein
the control unit causes the position change unit to switch the position of the thin wire in the microplasma producing unit to the removal position so that contamination and/or an oxide film is removed from the surface of the object to be bonded, and then causes the position of the thin wire to be switched to the deposition position so that the predetermined material is deposited on the surface of the object to be bonded, and then the control unit further causes the bonding process unit to perform the bonding process to a portion at which the predetermined material is deposited.

In this configuration, it is also preferable that the bonding process unit performs the bonding process to the object to be bonded that is held by a stage for bonding, the plasma treatment unit performs the surface treatment to a different object to be bonded that is held by a stage for surface treatment, the different object to be bonded being the same type as the object to be bonded subject to the bonding process by the bonding process unit, and the control unit controls to cause the bonding process and the surface treatment to be performed, in conjunction with each other, to corresponding portions of the same type of the objects to be bonded, respectively.

In the bonding apparatus according to the present invention, it is preferable that the control unit controls so that the bonding process and the surface treatment are performed to the same object to be bonded in conjunction with each other, and it is also preferable that the control unit controls so that the bonding arm and the plasma arm are moved integrally. It is further preferable that the plasma producing unit is an inductively coupled microplasma producing unit capable of, based on power supply to a high frequency coil that is wound about a tubular member made of an insulating body, spraying the plasma state gas in the tubular member from an opening of a tip end portion of the tubular member.

In the bonding apparatus according to the present invention, it is preferable that a chemical activity of the seal gas is equal to or lower than a chemical activity of the gas to be formed into plasma state gas, and it is also preferable that the seal gas is an inert gas.

The present invention has such an advantageous effect that the surface treatment to the object to be bonded can be effectively performed using the microplasma. Another advantageous effect with the present invention is that the surface treatment and the bonding process to the object to be bonded can be performed efficiently.

### BRIEF DESCRIPTION OF THE DRAWINGS

FIG. 1 is a configuration diagram of a wire bonding apparatus capable of performing a surface treatment and a bonding process in an embodiment according to the present invention;

FIG. 2 is an illustration showing a plasma arm having a plasma capillary at a tip end of an arm in the embodiment according to the present invention;

FIG. 3 is an illustration showing an entire configuration of a microplasma producing unit and a seal gas spraying unit in the embodiment according to the present invention;

FIG. 4 is an illustration showing how microplasma produced in the plasma capillary and a seal gas sprayed from an annular opening at a tip end of the seal gas nozzle are irradiated to a bonding pad of a semiconductor chip in the embodiment according to the present invention;

FIG. 5 is an illustration showing how the microplasma and the seal gas are irradiated to an object to be bonded in the embodiment according to the present invention;

FIG. 6 is a process chart showing procedures for the surface treatment performed in conjunction with the bonding process in the embodiment according to the present invention;

FIG. 7 is a process chart showing, as a different embodiment, an operation of a bump bonding apparatus;

FIG. 8 is a process chart showing, as a different embodiment, an operation of a flip chip bonding apparatus;

FIG. 9 is an illustration showing, as a different embodiment, how microplasma produced in a plasma capillary of the different embodiment and a seal gas sprayed from an annular opening at a tip end of a seal gas nozzle of the different embodiment are irradiated to a bonding pad of a semiconductor chip;

FIG. 10 is an illustration showing, as a different embodiment, an entire configuration of a microplasma producing unit and a seal gas spraying unit of the different embodiment;

FIG. 11 is an illustration showing, as a different embodiment, how microplasma produced in a plasma capillary of the different embodiment and a seal gas sprayed from an annular opening at a tip end of a seal gas nozzle of the different embodiment are irradiated to a bonding pad of a semiconductor chip;

FIG. 12 is an illustration showing, as a different embodiment, how microplasma produced in a plasma capillary of the different embodiment and a seal gas sprayed from an annular opening at a tip end of a seal gas nozzle of the different embodiment are irradiated to a bonding pad of a semiconductor chip;

FIG. 13 is a configuration diagram of, as a different embodiment, a wire bonding apparatus capable of performing the surface treatment and a the bonding process;

FIG. 14 is a configuration diagram of, as a different embodiment, components relating to the surface treatment;

FIG. 15 is an illustration showing, as a different embodiment, how microplasma produced in a plasma capillary and a seal gas sprayed from an annular opening at a tip end of a seal gas are irradiated to a bonding pad of a semiconductor chip;

FIG. 16 is an illustration showing, as a different embodiment, how microplasma including fine particles of gold is produced in a plasma capillary and how a seal gas sprayed from an annular opening at a tip end of a seal gas is irradiated to a bonding pad of a semiconductor chip;

FIG. 17 is a process chart showing, as the different embodiment, procedures for the surface treatment including surface removal and deposition performed in conjunction with the bonding process;

FIG. 18 is a process chart showing, as a different embodiment, an operation of a bump bonding apparatus;

FIG. 19 is a process chart showing, as a different embodiment, an operation of a flip chip bonding apparatus;

FIG. 20 is an illustration showing, as a different embodiment, a configuration of a single-stage wire bonding apparatus;

FIG. 21 is an illustration showing, as a different embodiment, an arm of the single-stage wire bonding apparatus;

FIG. 22 is an illustration showing, as a different embodiment, another configuration of the arm of the single-stage wire bonding apparatus; and

FIG. 23 is an illustration showing, as a different embodiment, another configuration of the single-stage wire bonding apparatus.

### DETAILED DESCRIPTION OF THE INVENTION

The preferred embodiments according to the present invention will be described in detail with reference to the accompanying drawings.

In the following description, an explanation relating to a surface treatment and a bonding process to a bonding pad of a semiconductor chip and a bonding lead on a substrate, and in particular, to a typical wire bonding technique will be described in detail. In the below description, the typical wire bonding technique includes a first bonding of a wire to the bonding pad of the semiconductor chip mounted on the substrate, and a second bonding of the wire to the bonding lead by extending the wire. A technique for connecting the bonding pad to the bonding lead is selected according to the properties of an object to be bonded, and the selection can be made from various techniques including wire bonding for a stacked device where semiconductor chips are stacked, a flip chip technique, a COF (Chip on Film) technique, and a BGA (Ball Grid Array) technique in addition to the wire bonding technique.

In the following, a variety of embodiments will be described as many as possible other than the common wire bonding technique. Of course, the present invention can be applied to examples of the surface treatment and the bonding process to the bonding pad and the bonding lead other than those described herein.

As described above, for the present invention, the bonding process is not limited to the wire bonding, and broadly means a process for connecting the bonding pad of a semiconductor chip to the bonding lead on a substrate. Accordingly, the bonding tool that is used in the bonding process is a capillary through which a wire is inserted in a case of wire bonding, but the bonding tool is not necessarily a capillary when a different technique is employed. For example, in the COF a collet that holds a semiconductor chip to perform the bonding is used, and thus in the COF a collet is the bonding tool.

Moreover, in the following description, the surface treatment is basically applied to both of the bonding pad and the bonding lead. However, the surface treatment to one of these can be omitted depending on the specific properties of the object to be bonded.

### FIRST EMBODIMENT

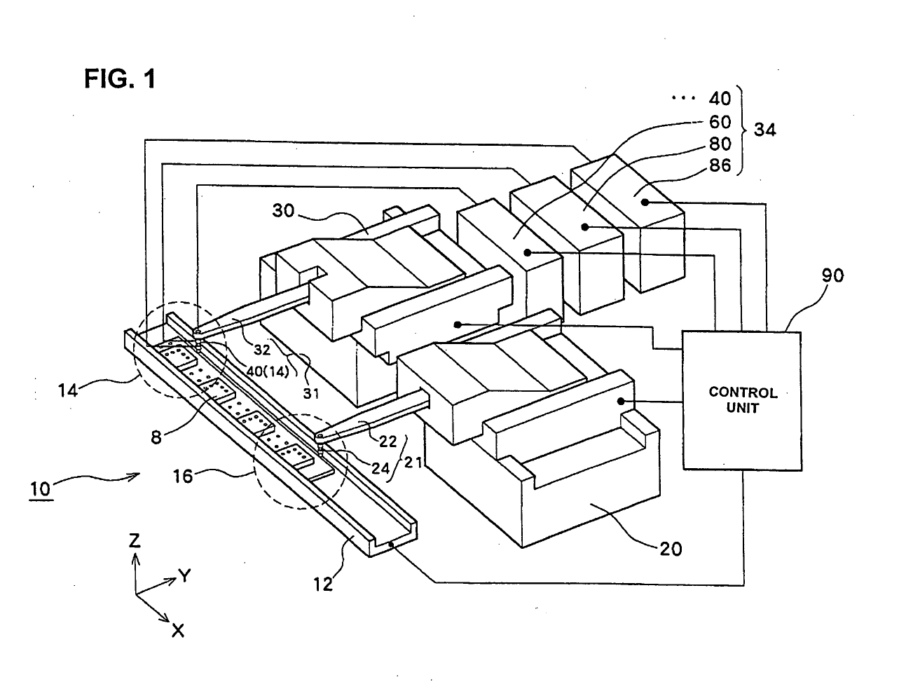

FIG. 1 is a configuration diagram of a wire bonding apparatus 10 capable of performing surface treatment and a bonding process. A semiconductor chip that is an object to be bonded 8 mounted on a substrate is also illustrated in FIG. 1.

The wire bonding apparatus 10 serves for performing, prior to the bonding, the surface treatment to the object to be bonded 8 by an effect of plasma state gas in a small region to which a wire is bonded, specifically, a bonding pad of the semiconductor chip and a bonding lead on the substrate.

The wire bonding apparatus 10 includes a transfer mechanism 12 that holds and transfers the object to be bonded 8 to a predetermined position, a bonding arm 21 in which a bonding capillary 24 is provided at a tip end of a bonding arm main body 22, an XYZ drive mechanism 20 that is used for bonding and drives the bonding arm 21 to move, a plasma arm 31 in which a plasma capillary 40 is provided at a tip end of a plasma arm main body 32, an XYZ drive mechanism 30 that is used for surface treatment and drives the plasma arm 31 to move, a gas supply unit 60 for surface treatment, a high frequency power supply unit 80 for surface treatment, a seal gas supply unit 86, and a control unit 90 that integrally controls the above listed components. In this structure, the plasma capillary 40, the gas supply unit 60, and the high frequency power supply unit 80 constitute a microplasma producing unit 34, and a seal gas nozzle 74 at the tip end of the plasma capillary 40 and the seal gas supply unit 86 constitute a seal gas spraying unit 35.

The XYZ drive mechanism 20 for bonding drives the bonding arm 21 to move to a given position in directions of X and Y axes shown in FIG. 1, and it is capable of moving the tip end of the bonding capillary 24 upward and downward along a Z axis at the given position. The bonding arm 21 includes the bonding arm main body 22 and the bonding capillary 24 provided at the tip end thereof. The XYZ drive mechanism 20 for bonding includes a high speed XY table, on which the bonding arm main body 22 is mounted, and a high speed Z motor, which drives the bonding arm main body 22 to swing, thereby moving the bonding capillary 24 provided at the tip end of the bonding arm main body 22 downward and upward. For positioning, a servomechanism (not shown in the drawings) using a sensor is employed.

The bonding arm 21 is, as described above, constituted by the bonding arm main body 22 and the bonding capillary 24 provided at the tip end thereof. The bonding arm 21 also serves to supply ultrasonic energy to the bonding capillary 24 by means of an ultrasonic transducer that is not shown, and to press a bonding wire inserted through the bonding capillary 24 to the object to be bonded 8 to bond. The bonding capillary 24 is, as well-known, a thin tubular component through which the bonding wire is inserted. A thin wire made of such as gold or aluminum can be used as the bonding wire. It should be noted that, in FIG. 1, arrangements such as a spool that feeds the bonding wire and a clamper that clamps or releases the movement of the bonding wire are not shown.

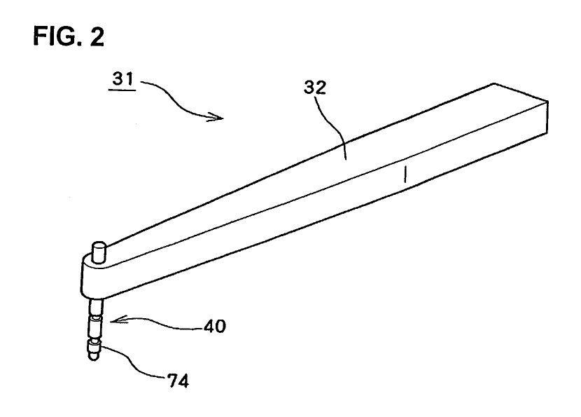

The XYZ drive mechanism 30 for surface treatment drives the plasma arm 31, which is provided with the plasma capillary 40 for surface treatment that will be described later at the tip end of the plasma arm 31, to move to a given position in the directions of the X and Y axes shown in FIG. 1, and the XYZ drive mechanism 30 is capable of moving the tip end of the plasma capillary 40 upward and downward along the Z axis at the given position. The plasma arm 31 includes, as shown in FIG. 2, the plasma arm main body 32 and the plasma capillary 40 provided at the tip end thereof. Further, the seal gas nozzle 74 is provided at the tip end of the plasma capillary 40. As seen from FIG. 1, the appearances of the plasma arm main body 32 and the plasma capillary 40 are respectively similar to the appearances of the bonding arm main body 22 and the bonding capillary 24.

Functions of the XYZ drive mechanism 30 for surface treatment are substantially the same as those of the XYZ drive mechanism 20 for bonding. A difference is that the XYZ drive mechanism 20 for bonding needs to drive to move at high speed and high accuracy, while an accuracy in the positioning for the XYZ drive mechanism 30 for surface treatment does not need to be as high as that of the XYZ drive mechanism 20. Specifically, the regions to which the surface treatment is applied are larger than a projected area at which the wire is bonded to the bonding pad or the bonding lead, and a variation thereof can be tolerated to some extent. Consequently, performances of an XY table and an X motor that constitute the XYZ drive mechanism 30 for surface treatment can be moderate as compared to those of the XYZ drive mechanism 20 for bonding.

Further, in the above-described structure, the XYZ drive mechanism 30 for surface treatment, the plasma arm main body 32, and the plasma capillary 40 have substantially the same functions as those of the XYZ drive mechanism 20 for bonding, the bonding arm main body 22, and the bonding capillary 24 as described above; accordingly, controlled movements of the plasma capillary 40 and the bonding capillary 24 can be conducted in the same sequence by calibrating the positions of the tip end of the plasma capillary 40 and the tip end of the bonding capillary 24. Specifically, by way of applying the same sequence program, the tip end of the plasma capillary 40 and the tip end of the bonding capillary 24 can be moved to the object to be bonded 8 in perfectly the same manner. In other words, providing the same sequence program to the XYZ drive mechanism 30 for surface treatment and to the XYZ drive mechanism 20 for bonding at the same time causes the movement of the tip end of the plasma capillary 40 to completely coincide with the movement of the tip end of the bonding capillary 24. As a result, such an operation can be obtained that an apparatus for surface treatment and an apparatus for bonding make the completely identical operations at the same time.

The plasma capillary 40, the gas supply unit 60, and the high frequency power supply unit 80 that constitute the microplasma producing unit 34 for surface treatment, and the seal gas nozzle 74 and the seal gas supply unit 86 that constitute the seal gas spraying unit 35 will be described after an explanation for other components (the transfer mechanism 12 and the control unit 90) is given.

The transfer mechanism 12 serves to carry the object to be bonded 8 to a stage 14 for surface treatment, which is a region where the treatment by the plasma capillary 40 is performed, and to position and fix the object to be bonded 8 on the stage 14. The transfer mechanism 12 also servers to have the object to be bonded 8 go through the surface treatment, then to carry the object to be bonded 8 to a stage 16 for bonding, which is a region where the bonding by the bonding capillary 24 is performed, and further to position and fix the object to be bonded 8 on the stage 16. The transfer mechanism 12 further serves to have the object to be bonded 8 go through the bonding process. The transfer mechanism 12 as described above can be a mechanism with which an object to be transferred is clamped and transferred.

The control unit 90 is connected to the transfer mechanism 12, the XYZ drive mechanism 20 for bonding, the XYZ drive mechanism 30 for surface treatment, the gas supply unit 60, the high frequency power supply unit 80, the seal gas supply unit 86, and such. The control unit 90 is an electronic circuit device capable of controlling these components so as to perform the surface treatment to the object to be bonded 8, and then performs the bonding process. These functions of the control unit 90 can be realized based on software. Specifically, the control of the components by the control unit 90 can be realized by executing a wire bonding program that embodies procedures for executing the surface treatment in conjunction with the bonding process. A part of the functions can be realized based on hardware.

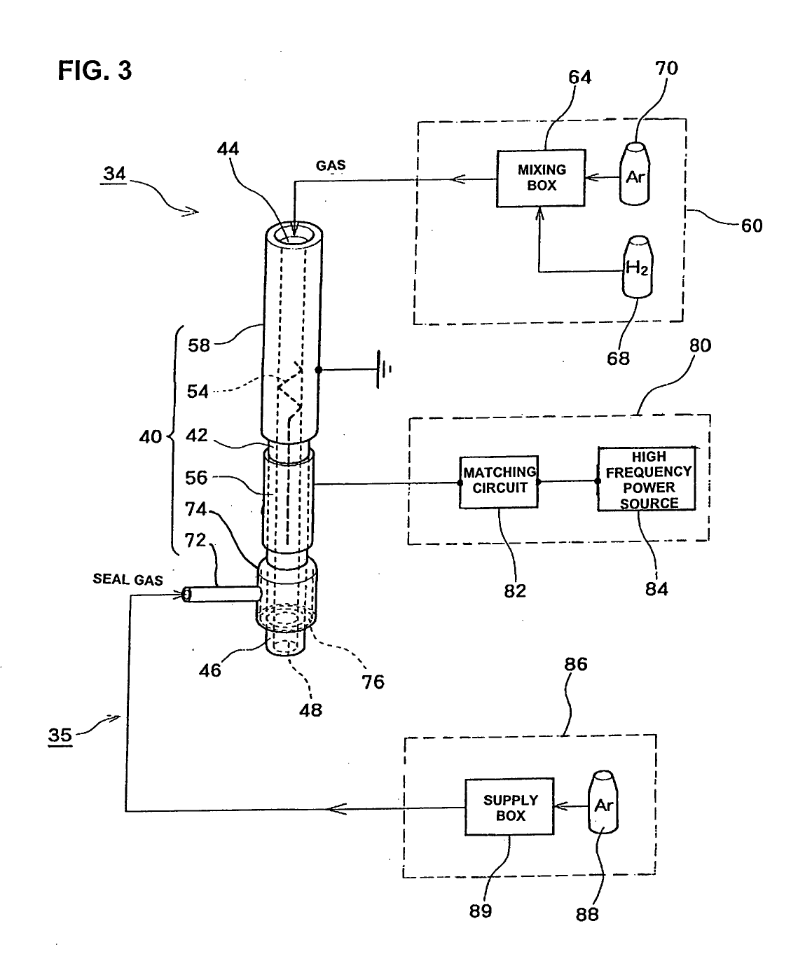

Referring now to FIG. 3, the microplasma producing unit 34 for surface treatment and the seal gas spraying unit 35 will be described in detail. FIG. 3 shows an entire configuration of the microplasma producing unit 34.

As described above, the microplasma producing unit 34 includes the plasma capillary 40 provided at the tip end of the plasma arm 31 (see FIGS. 1 and 2), the gas supply unit 60 connected to the plasma capillary 40, and the high frequency power supply unit 80. The seal gas spraying unit 35 includes the seal gas nozzle 74 provided at the tip end of the plasma capillary 40 and the seal gas supply unit 86.

The plasma capillary 40 serves as a component to produce microplasma for surface treatment within a thin tubular member made of an insulating body, to spray the produced microplasma from the tip end opening to irradiate it to the object to be bonded, and further to spray a seal gas to enclose the sprayed microplasma and seal the microplasma from the ambient air. An area to be irradiated with the plasma is defined by, for example, the size of the tip end opening of the plasma capillary 40, and such an area is sufficiently small so that the sprayed plasma is called microplasma.

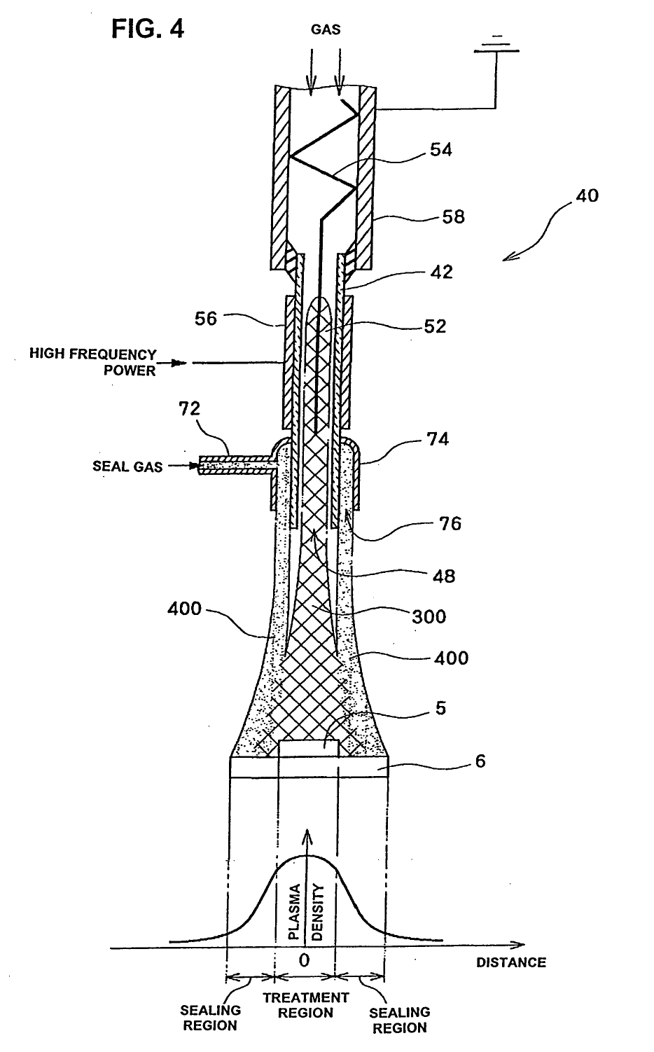

The plasma capillary 40 includes a tubular plasma capillary main body 42 made of an insulating body, a pipe 58 made of conductive material and provided with the plasma capillary main body 42, a cylindrical external electrode 56 (see FIG. 4) provided outside of the plasma capillary main body 42, and a linear internal electrode 54 one end of which is in contact with an inner surface of the pipe 58 and the other end of which is provided at the center of the plasma capillary main body 42. The seal gas nozzle 74 of the plasma capillary 40 is provided to an outer circumference of the tip end portion of the plasma capillary main body 42.

The plasma capillary main body 42 is supplied with a gas as a source of microplasma from the gas supply outlet 44 for plasma provided at the upper end of the pipe 58. The overall size of the plasma capillary main body 42 is approximately the same as the bonding capillary 24. For example, the plasma capillary main body 42 has a diameter of a main body opening 48 at the tip end portion 46 is about 0.05 mm, and can be made of ceramic such as alumina similarly to the bonding capillary 24. Further, the diameter of the main body opening 48 can be as large as about 0.5 mm to 1.0 mm.

The cylindrical external electrode 56 provided on an outer surface of the plasma capillary main body 42 can be made of metal material such as stainless steel, and can be closely attached to the plasma capillary main body 42 or provided with a slight gap from the plasma capillary main body 42. One end of the internal electrode 54 that is provided along the center axis of the plasma capillary main body 42 extends toward substantially the same position as the position of an end of the external electrode 56 on the tip of the capillary 40. Further, for plasma production and stability, it is preferable that the internal electrode is made of a high melting point precious metal.

The cylindrical seal gas nozzle 74 has a larger inner diameter than the diameter of the plasma capillary main body 42, and it is provided outside of the plasma capillary main body so as to be concentrical with the plasma capillary main body 42. The upper end of the seal gas nozzle 74 is closed and fixed to the plasma capillary main body 42, and the lower end of the seal gas nozzle 74 constitutes an open end. The seal gas nozzle 74 and the plasma capillary main body 42 constitute a double tube so that an annular channel along the longitudinal axis of the plasma capillary main body 42 is formed between the seal gas nozzle 74 and the plasma capillary main body 42. The main body opening 48 at the lower end of the plasma capillary main body 42 projects beyond the opening at the lower end of the seal gas nozzle 74, and an open end of the lower end of the seal gas nozzle 74 constitutes an the annular opening 76. To the seal gas nozzle 74, a seal gas supply pipe 72 that supplies the seal gas is fixed. The seal gas nozzle 74 can be made of ceramics such as alumina similarly to the plasma capillary main body 42. The seal gas nozzle 74 is not limited to have a cylindrical shape as described above, as long as the seal gas can be sprayed so as to enclose the microplasma sprayed from the main body opening 48 of the plasma capillary main body 42, and it can be a tube having a square or sexanglular cross-section, or can be an externally polygonal shape tube with a circular cylindrical hole inside. Further, it is preferable to make the tip end to be tapered in a nozzle shape when it is desired to increase the flow rate of the seal gas sprayed from the annular opening 76.

The gas supply unit 60 serves to supply the gas as a source of the microplasma. Specifically, the gas supply unit 60 includes a mixing box 64 in which a gas for surface treatment is mixed with a carrier gas, various gas sources, and various pipings that respectively connect these gas sources to the plasma capillary 40. In this configuration, the various gas sources include a hydrogen gas source 68 for reduction treatment as a gas source for surface treatment and an Argon gas source 70 as a carrier gas source.

The mixing box 64 serves to mix a reducing gas that is supplied with the carrier gas with an appropriate mixture proportion, and to supply the mixture gas to the gas supply outlet 44 for plasma of the plasma capillary 40. The mixing box 64 is controlled under the control unit 90. Because an amount of gas consumption is very small, a small gas cylinder can be used as each gas source. It should be understood that the gas source can be an external gas source connected to the mixing box 64 through a dedicated piping.

When the hydrogen gas is used as the gas source for surface treatment, an oxide film and such on the surface of the object to be bonded can be removed by reduction. In addition to this, depending on the type of the object to be bonded, a fluorinated etching gas can be used as the gas source for surface treatment.

The high frequency power supply unit 80 serves to supply high frequency power for continuing the production of the microplasma. The high frequency power supply unit 80 includes the external electrode 56 (see FIG. 4) provided on an outer surface of the plasma capillary main body 42, a matching circuit 82, and a high frequency power source 84. The matching circuit 82 is a circuit for suppressing power reflection when supplying high frequency power to the external electrode 56. As the matching circuit 82, a circuit constituting an LC resonator and such is used, for example. As the high frequency power source 84, a power source with a frequency of 100 MHz to 500 MHz can be used, for example. Magnitude of power to be supplied is determined considering the type and the flow rate of the gas supplied from the gas supply unit 60, and stability of the microplasma. The high frequency power source 84 is controlled under the control unit 90.

The seal gas supply unit 86 serves to supply the gas as a source of the seal gas that is sprayed from the tip end of the seal gas nozzle. Specifically, the seal gas supply unit 86 includes a seal gas source and a piping that connects the seal gas source to the plasma capillary 40. In this configuration, an inert gas or nitrogen is used as the seal gas in order not to avoid oxidation of a surface of the bonding pad or the bonding lead, as well as to avoid causing surface deterioration that can reduce intensity of electrical junction and mechanical junction. Further, because the seal gas is to contact with the plasma state gas, a gas whose chemical activity is roughly equal to or lower than that of the gas supplied as a plasma producing source is used as the seal gas. Consequently, in a case in which Argon gas is used as the carrier gas source for producing plasma, Argon gas or either of Helium gas or Neon gas that is less active than Argon gas is used. In this embodiment, Argon gas is used as the carrier gas for producing plasma, and therefore, Argon gas source 88 is used for the seal gas source too. When, nitrogen gas is used as the carrier gas for producing plasma source, a nitrogen gas source can be used as the seal gas source.

A supply box 89 serves to supply the seal gas that has been transferred thereto to the seal gas supply pipe 72 of the plasma capillary 40. The supply box 89 is controlled under the control unit 90. Because the amount of gas consumption is very small, a small gas cylinder can be used as the seal gas source. The seal gas source can indeed be an external gas source connected to the supply box 89 through a dedicated piping.

FIG. 4 shows the manner of working of the microplasma producing unit 34 and the seal gas spraying unit 35, in which microplasma 300 produced in the plasma capillary 40 and the seal gas sprayed from the annular opening 76 at the tip end of the seal gas nozzle 74 are irradiated to a bonding pad 5 of a semiconductor chip 6.

The following procedures are performed in order to produce the microplasma 300. First, the gas supply unit 60 (see FIG. 3) is controlled to supply a gas of an appropriate flow rate to the gas supply outlet 44 of the plasma capillary 40. The supplied gas flows out of the plasma capillary 40 from the main body opening 48 of the tip end portion. Next, the high frequency power supply unit 80 (see FIG. 3) is controlled to supply appropriate high frequency power to the external electrode 56. The above described appropriate conditions of the gas flow rate and high frequency power can be obtained previously by experiments. Then, when the conditions for the supplied gas and for the high frequency power are both appropriate, the microplasma 300 is produced in the flowing gas due to the high frequency power. The plasma region 52 where the supplied gas is formed into plasma state gas inside the plasma capillary main body 42 is approximately positioned downstream of the gas from the position where the upper end of the external electrode 56 is located. The produced microplasma 300 is sprayed from the main body opening 48 at the tip end of the plasma capillary 40 and flows toward the bonding pad 5 as the microplasma spreads.

On the other hand, in order to produce a flow of the seal gas, first, the seal gas supply unit 86 (see FIG. 3) is controlled to supply the seal gas of an appropriate flow rate to the seal gas supply pipe 72 of the plasma capillary 40. The supplied seal gas flows through the annular flow channel within the seal gas nozzle 74 and is sprayed from the annular opening 76 at the tip end as an annular seal gas flow 400. The sprayed seal gas flow 400 flows toward the bonding pad 5 while the width of the flow channel becomes wider in a manner such that outer diameter of the annular cross-section becomes greater and inner diameter becomes smaller. Then, the seal gas is brought into contact with outer circumference portion of the microplasma 300 between the main body opening 48 of the plasma capillary 40 and the bonding pad 5, and an integral flow in which the seal gas flow 400 surrounds the microplasma 300 is formed and reaches the bonding pad 5.

As can be seen from the graph shown in the lower part of FIG. 4, plasma density is high in the central portion of the integral gas flow because the seal gas does not come inside the gas flow, and gradually decreases toward the peripheral portion since the seal gas flow 400 and the microplasma 300 are mixed. At the outer circumference at which the integral flow is brought into contact with the ambient air, only the seal gas flows. The seal gas flow surrounding the microplasma 300 in this manner prevents an oxygen component and/or contamination in the ambient air from being mixed into the microplasma 300. The bonding pad 5 is, as a result, brought into contact with the central portion with high plasma density, and thus the removal process of removing such as an oxide film on the surface of the bonding pad 5 is performed.

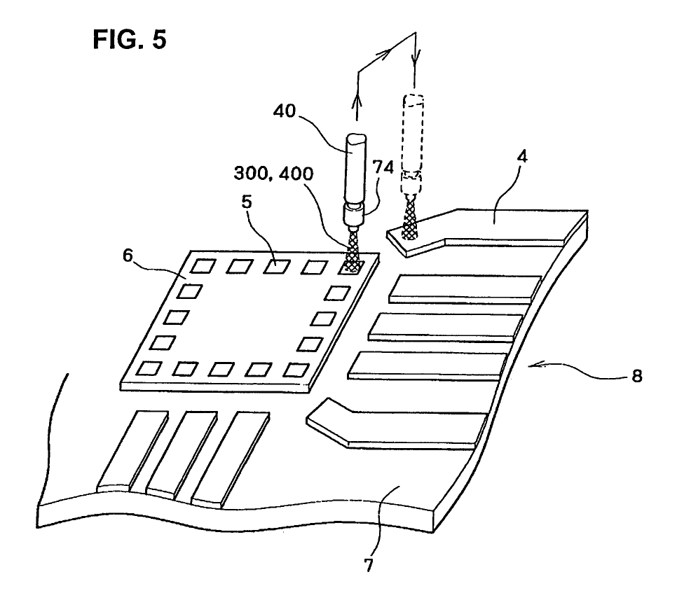

In this embodiment, the diameter of the main body opening 48 is on the order of 0.05 mm. Accordingly, by way of taking an appropriate distance between the main body opening 48 and the object to be bonded, the portion of the integral flow with high plasma density is irradiated only to a small region of the bonding pad or the bonding lead. On the other hand, by way of keeping the distance of the main body opening 48 away from the object to be bonded, the microplasma 300 and the seal gas flow 400 are prevented from giving any effect to the object to be bonded even if the microplasma 300 and the seal gas flow 400 are kept sprayed. Consequently, it is possible to control the effect of the microplasma 300 to the object to be bonded by moving the plasma capillary 40 upward and downward. FIG. 5 illustrates this movement of the plasma capillary 40. In FIG. 5, the object to be bonded 8 is a semiconductor chip 6 mounted on a circuit board 7. FIG. 5 further illustrates how the XYZ drive mechanism 30 for surface treatment is appropriately controlled to move the position of the plasma capillary 40, and how the microplasma 300 and the seal gas flow 400 are irradiated from the plasma capillary 40 at positions of the bonding pad 5 of the semiconductor chip 6 and a bonding lead 4 on the circuit board 7, respectively. Further, when the main body opening 48 is on the order of 0.5 to 1.0 mm in diameter, by way of taking an appropriate distance to the object to be bonded, the microplasma 300 and the seal gas flow 400 can be irradiated to a plurality of bonding pads and a plurality of bonding leads simultaneously.

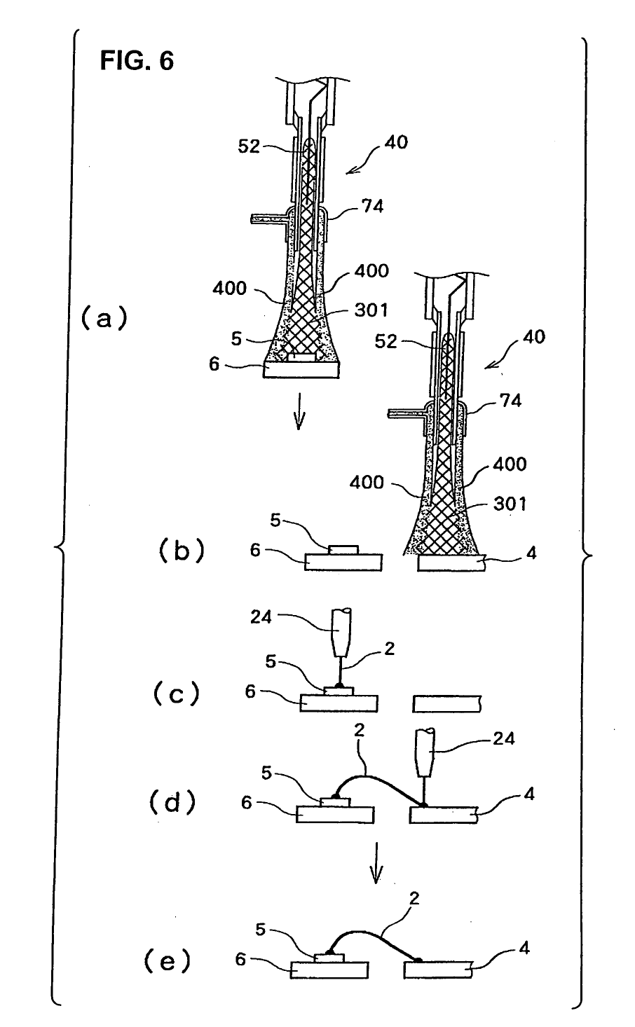

An operation of the wire bonding apparatus 10 configured as above will be described below referring to FIG. 6. FIG. 6 shows the procedures for the surface treatment performed in conjunction with the bonding process.

In order to perform the wire bonding, first, the wire bonding apparatus 10 is activated to transfer the object to be bonded 8 to the stage 14 for surface treatment using the transfer mechanism 12, and positions the object to be bonded 8 on the stage 14 (surface treatment positioning step).

Then, according to an instruction from the control unit 90, the microplasma producing unit 34 is activated, and the microplasma 300 is produced in the plasma capillary 40. The type of the gas is limited to the carrier gas, and the gas for surface treatment is not need to be mixed yet. At this time, the plasma capillary 40 stays away from the object to be bonded 8, and the microplasma 300 has no effect to the object to be bonded 8 (microplasma producing step).

Next, when the wire bonding program is run, positioning is performed on the stage 14 for surface treatment in a similar manner as the case of the stage 16 for bonding, and the plasma capillary 40 is moved immediately and high above the first one of the bonding pads 5 (bonding pad positioning step).

Then, according to an instruction from the control unit 90, the reducing gas, i.e. hydrogen, is mixed into the carrier gas to make the microplasma into the reducing microplasma 301 (microplasma setting step).

Subsequently, according to an instruction from the control unit 90, the seal gas flow 400 is sprayed from the annular opening 76 at the tip end of the seal gas nozzle of the plasma capillary 40 (seal gas setting step).

The wire bonding program then causes the plasma capillary 40 to be move down toward the bonding pad 5. At this time, the position of the tip end of the plasma capillary 40 is previously offset to the tip end of the bonding capillary by a height in a range within which the reducing microplasma 301 and the seal gas flow 400 have an effect. By this, when the wire bonding program causes the first bonding to be executed, the tip end of the plasma capillary 40 is positioned right above the bonding pad 5 at a height at which the integral gas flow of the reducing microplasma 301 and the seal gas flow 400 is irradiated to the bonding pad 5 in an optimal manner to seal the ambient air. At this point, the integral gas flow of the reducing microplasma 301 and the seal gas flow 400 removes the thin oxide film on the surface of the bonding pad 5 in an atmosphere in which the reducing microplasma 301 is sealed from the ambient air to obtain a clean surface (bonding pad surface treatment step). Illustration (a) of FIG. 6 shows how the above operation is performed.

Next, the wire bonding program causes the plasma capillary 40 to be pulled upward and then moved immediately above the bonding lead 4 (bonding lead positioning step).

The wire bonding program then causes the plasma capillary 40 to be moved down toward the bonding lead 4. Subsequently, the tip end of the plasma capillary 40 is positioned right above the bonding lead 4 at a height at which the integral gas flow of the reducing microplasma 301 and the seal gas flow 400 is irradiated to the bonding lead 4 in an optimal manner to seal the ambient air. At this point, the integral gas flow of the reducing microplasma 301 and the seal gas flow 400 removes such as contamination and/or foreign substances on the surface of the bonding lead 4 in an atmosphere in which the reducing microplasma 301 is sealed from the ambient air to obtain a clean surface (bonding lead surface treatment step). Illustration (b) of FIG. 6 shows how the above operation is performed.

Then, as the wire bonding program causes the operation to advance, the control unit 90 controls the microplasma producing unit 34 to proceed the surface treatment to each bonding pad 5 and each bonding lead 4. Consequently, when the wire bonding program causes the operation to end, all of the bonding pads 5 and all of the bonding leads 4 of the objects to be bonded 8 have gone through the surface treatment (surface treatment completing step).

Next, according to an instruction from the control unit 90, the transfer mechanism 12 transfers the object to be bonded 8 that has gone through the surface treatment to the stage 16 for bonding, and positions the object to be bonded 8 (bonding process positioning step).

Then, the wire bonding program is run, and the first bonding to the bonding pad 5 is performed by a known method, and then the second bonding to the bonding lead 4 is performed. Illustrations (c) and (d) of FIG. 6 show how this operation is performed. When the bonding is thus being performed, the bonding pad 5 and the bonding lead 4 are subject to the surface treatment in a state being sealed from the ambient air, and therefore kept in a state in which the possibility of re-oxidation and/or recontamination is reduced. Consequently, the bonding process can be performed more stably. Illustration (e) of FIG. 6 shows how the bonding process is performed in this manner. After repeating this operation, when the wire bonding program causes the operation to end, the bonding process for all of the bonding pads 5 and all of the bonding leads 4 of the objects to be bonded 8 is completed (bonding process completing step).

In the above, the surface treatment to the bonding pad 5 and the bonding lead 4 is described as removing of the thin oxide film, the contamination, and/or the foreign substances by the reducing microplasma 301. However, a different type of surface treatment can be employed depending on the property of the object to be bonded 8. The type of the gas and the plasma intensity can be selected by a user as an input to the control unit 90.

The above described embodiment prevents the oxygen component and/or the contamination in the ambient air from being mixed into the microplasma 300 by forming the integral flow such that the seal gas flow 400 surrounds the microplasma 300 that then reaches the bonding pad 5 or the bonding lead 4 of the object to be bonded, and performs the removal process, by the central portion having high plasma density, for removing the thin oxide film, the contamination, and/or the foreign substances from the surface of the bonding pad 5 or the bonding lead 4 as a portion to be bonded. As a result, it is possible to reduce the possibility of re-oxidation and/or re-contamination in the surface treatment using the microplasma, and effectively realize the surface treatment to the object to be bonded using the microplasma. Moreover, there is an advantage that the bonding process can be performed more stably by employing such effective surface treatment.

Further, this embodiment includes, in addition to a bonding process unit, the microplasma producing unit 34 capable of spraying the microplasma 300 from the main body opening 48 at the tip end portion of the plasma capillary 40 and the seal gas spraying unit 35 capable of spraying the seal gas flow 400 from the annular opening 76 at the tip end of the plasma capillary 40. Accordingly, a single bonding apparatus is provided with the functions of irradiating the microplasma 300 and the seal gas flow 400 to a small region of the object to be bonded to perform the surface treatment with reduced damage, re-oxidation, and re-contamination, as well as of performing the bonding process. Therefore, there is an advantage that the effective surface treatment and the bonding process to the object to be bonded can be efficiently performed.

Further, in this embodiment, the movement of the bonding arm 21 having the bonding capillary 24 and the movement of the plasma arm 31 having the plasma capillary 40 are controlled in conjunction with each other, and therefore it is possible to perform the surface treatment efficiently with respect to the bonding process. Here, “in conjunction” means operations are performed in parallel at the same time, and not in batch processing. However, it also includes a synchronous operation and an operation performed not synchronously but substantially at the same time in a sequential manner.

Further, assuming that the same type of the objects to be bonded are A and B, then in the shown embodiment, the bonding process unit performs the bonding process to one portion, for example, the bonding pads 5 of either A or B on the stage 16 for bonding, and a plasma treatment unit performs the surface treatment to the same portion, i.e. the bonding pad 5 of the other of A and B on the stage 14 for surface treatment. Accordingly, the bonding process and the surface treatment can be performed simultaneously and in parallel. For example, the bonding process and the surface treatment can be executed by means of similar sequence software.

### SECOND EMBODIMENT

The microplasma producing unit 34 and the seal gas spraying unit 35 described in FIG. 3 can be used in a bump bonding apparatus. A typical bump bonding apparatus is for forming a gold bump in a flip chip technique. Specifically, in a bump bonding apparatus, a gold wire is bonded to the bonding pad of the chip to be used as a gold bump using a wire bonding principle. This apparatus performs a process that sort of corresponds to a process omitting the second bonding from the common wire bonding process. In other words, the bump bonding apparatus is an equivalence of the wire bonding apparatus 10 illustrated in FIG. 1 in which the object to be bonded 8 transferred by the transfer mechanism 12 is replaced with a finished wafer on which completed LSIs are arranged.

When a finished wafer is used as the object to be bonded 8, the surface treatment is performed to the bonding pad 5 of each of a plurality of the completed LSIs on the stage 14 for surface treatment. Subsequently, when the surface treatment to all bonding pads of a single finished wafer is completed, the wafer is transferred to the stage 16 for bonding. Then, a bump is formed on the bonding pad 5 of each of the plurality of completed LSIs. In this case, a bump bonding program used for the XYZ drive mechanism 20 for bonding can also be applied to the XYZ drive mechanism 30 for surface treatment in a similar manner as described referring to FIG. 6, and the processes can be made common.

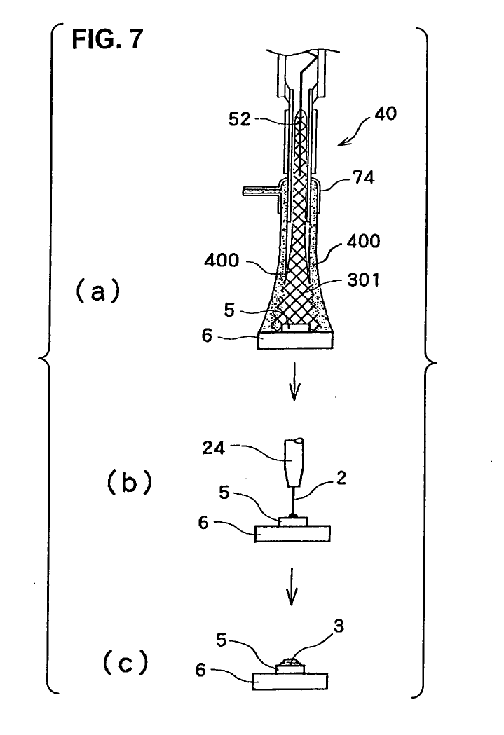

An operation of the bump bonding apparatus that is configured by, except for the transfer mechanism 12, the same remaining components in the same manner as the wire bonding apparatus 10 shown in FIG. 1 will be described below referring to the process chart of FIG. 7.

The surface treatment is performed using the plasma capillary 40 on the stage 14 for surface treatment. According to an instruction from the control unit 90, the reducing gas, i.e. hydrogen, is mixed into the carrier gas to make the microplasma into the reducing microplasma 301.

Subsequently, the bump bonding program is applied to the XYZ drive mechanism 30 for surface treatment, the plasma capillary 40 is moved immediately above the first one of the bonding pads 5 at a position of a first of the LSIs.

Then, the plasma capillary 40 moves down, and the tip end of the plasma capillary 40 is positioned right above the bonding pad 5 at a height at which the integral gas flow of the reducing microplasma 301 and the seal gas flow 400 is irradiated to the bonding pad 5 in an optimal manner to seal the ambient air. At this point, the integral gas flow of the reducing microplasma 301 and the seal gas flow 400 removes the thin oxide film on the surface of the bonding pad 5 in an atmosphere in which the reducing microplasma 301 is sealed from the ambient air to obtain a clean surface (bonding pad surface treatment step). Illustration (a) of FIG. 7 shows how the above operation is performed. This step is the same as the step described in Illustration (a) of FIG. 6.

Then, as the bump bonding program causes the operation to advance, the surface treatment is sequentially performed to the bonding pad 5 at the position of each of the LSIs. Consequently, when the wire bonding program causes the operation to end, all of the bonding pads 5 of the object to be bonded 8 have gone through the surface treatment (surface treatment completing step).

Next, according to an instruction from the control unit 90, the transfer mechanism 12 transfers the finished wafer that has gone through the surface treatment to the stage 16 for bonding, and positions the finished wafer (bonding process positioning step).

Then, the bump bonding program is run, and the gold wire is bonded to form the gold bump on the first of the bonding pads 5 at the position of the first one of the LSIs. Illustration (b) of FIG. 7 shows how this operation is performed. While the bonding is thus being performed, the bonding pad 5 is subject to the surface treatment in a state being sealed from the ambient air, and therefore being kept in a state in which the possibility of re-oxidation and/or re-contamination is reduced. Consequently, the bonding process can be performed more stably. Illustration (c) of FIG. 7 shows how the bonding process is completed and a gold bump 3 is formed in this manner. After repeating this operation, the gold bump 3 is formed on each of the bonding pads 5 of all of the LSIs on the single wafer.

The above described Second Embodiment, similarly to the previously explained First Embodiment, has the advantageous effects that the possibility of re-oxidation and/or re-contamination in the surface treatment can be reduced using the microplasma, and the effective surface treatment to the object to be bonded can be realized using the microplasma.

### THIRD EMBODIMENT

The microplasma producing unit 34 and the seal gas spraying unit 35 that are described in FIG. 3 can be applied to a flip chip bonding apparatus. A typical flip chip bonding apparatus is for mounting a chip, on which a bump is formed as described in FIG. 7, to a circuit board with face down. Accordingly, the bump 3 on the semiconductor chip 6 and the bonding lead 4 are connected in flip chip bonding. In order to realize the face down mounting (or face down bonding), the chip is flipped over, and a bonding tool for face down bonding is a collet for holding the flipped over chip instead of the bonding capillary. Thus, a specific configuration of the flip chip bonding apparatus is different from the configuration of the wire bonding apparatus illustrated in FIG. 1 to a large degree.

The microplasma producing unit 34 is utilized in the flip chip bonding apparatus when the surface treatment is performed to the bump 3 of the chip before the chip is flipped over and held by the collet, and when the surface treatment is performed to the bonding lead 4 before the face down bonding is performed using the collet.

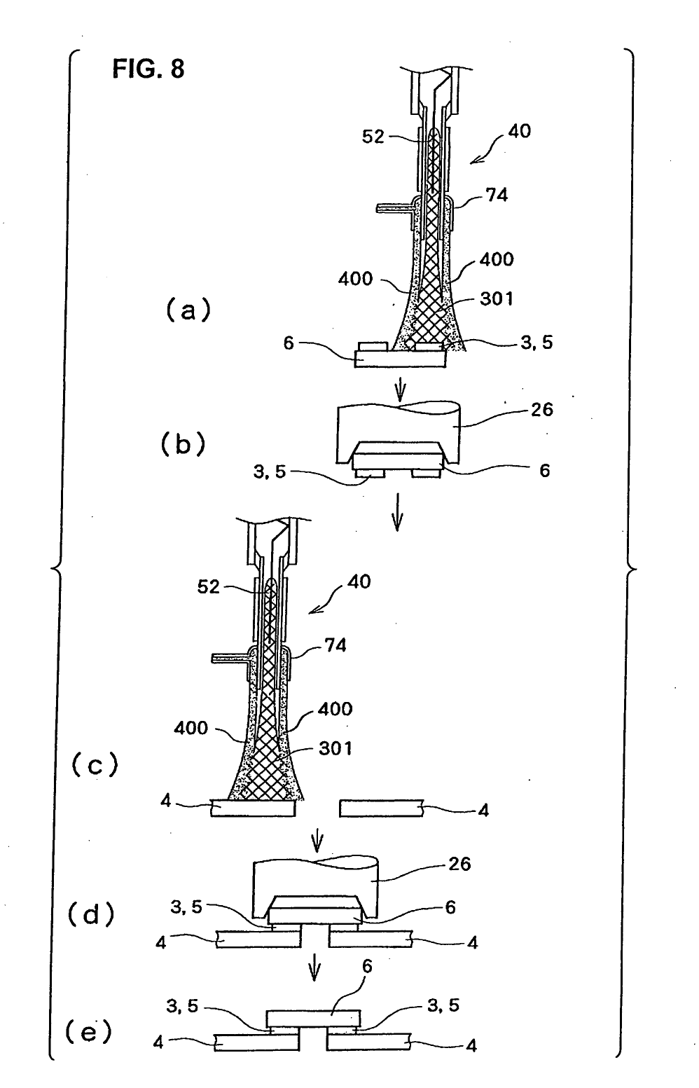

FIG. 8 illustrates the procedures for utilizing the microplasma producing unit 34 in the flip chip bonding apparatus.

First, the reducing microplasma 301 and the seal gas flow 400 are irradiated from the plasma capillary 40 to the bump 3 on the bonding pad 5 of the semiconductor chip 6. Illustration (a) of FIG. 8 shows how this operation is performed.

Next, the semiconductor chip 6 that has gone through the surface treatment is flipped over, and held by a collet 26 in a face down state. The “face down state” refers to the state in which the bump 3 faces downward. The collet 26 can hold the semiconductor chip 6 by vacuum suction. Illustration (b) of FIG. 8 shows how this operation is performed.

Next, the surface treatment is performed to the bonding lead 4 of the circuit board in the same manner as described above. Illustration (c) of FIG. 8 shows how this operation is performed.

The semiconductor chip 6 held in the face down state is positioned with respect to the bonding lead 4, and the face down bonding is performed as shown in Illustration (d) of FIG. 8. Illustration (e) of FIG. 8 shows the bump 3 which is on the semiconductor chip 6 is bonded to the bonding leads 4.

The above-described embodiment, similarly to the previously explained embodiment, has the advantageous effects that the possibility of re-oxidation and/or re-contamination in the surface treatment can be reduced using the microplasma, and the effective surface treatment to the object to be bonded can be realized using the microplasma.

### FOURTH EMBODIMENT

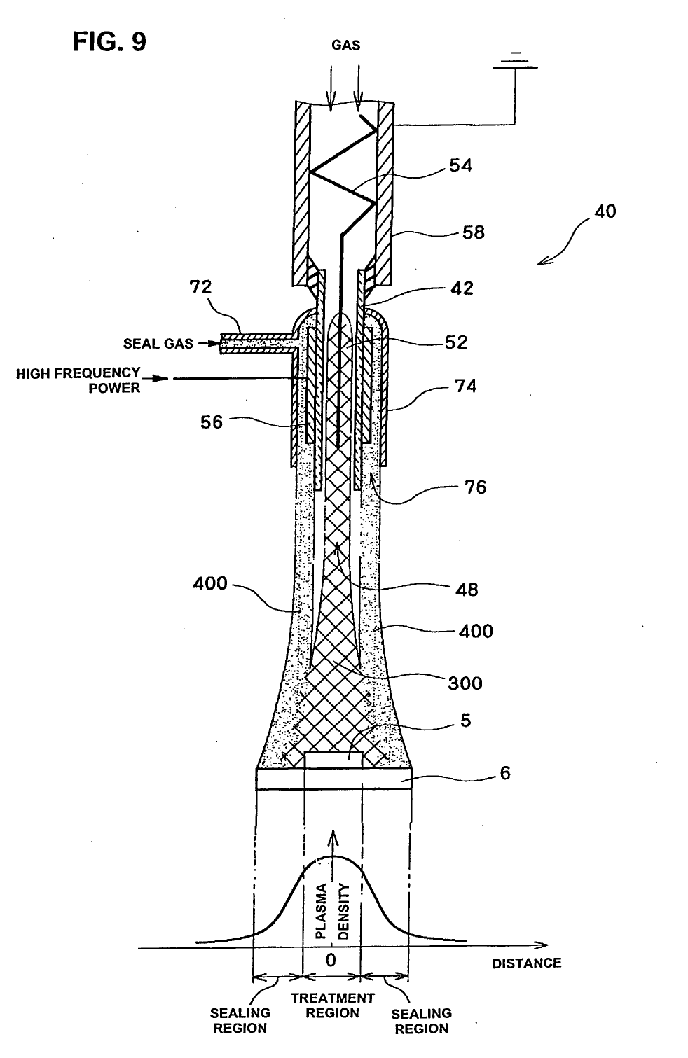

FIG. 9 illustrates the plasma capillary 40 of a different embodiment. The like components as in the embodiment of the plasma capillary shown in FIGS. 3 and 4 are indicated by the like numerals, and an explanation for these components is omitted.

As shown in FIG. 9, in the plasma capillary 40 of this embodiment, an external electrode 56 and an internal electrode 54 both for producing plasma and the seal gas nozzle 74 are positioned in parallel along a direction of the gas flow. As shown in FIG. 9, the upper end of the seal gas nozzle 74 is fixed to the plasma capillary main body 42 between the external electrode 56 and the pipe 58. The cylindrical seal gas nozzle 74 is provided outside of the external electrode 56 attached to the outer surface of the plasma capillary main body 42. A power feeder to the external electrode 56 is penetrating through the seal gas nozzle 74. As a result, the external electrode 56 is positioned in the annular channel between the seal gas nozzle 74 and the plasma capillary main body 42, which causes an entire length shorter. In addition, a distance from lower ends of the external electrode 56 and the internal electrode 54 to the main body opening 48 becomes shorter, and therefore the plasma intensity at the main body opening 48 can be maintained high.

In the above-described structure, it is preferable to make the tip end to be tapered in a nozzle shape when it is desired to increase the flow rate of the seal gas flow 400 sprayed from the annular opening 76.

The operation and effects of the bonding apparatus 10 that uses the plasma capillary 40 according to this embodiment are the same as those described in the above embodiments.

### FIFTH EMBODIMENT

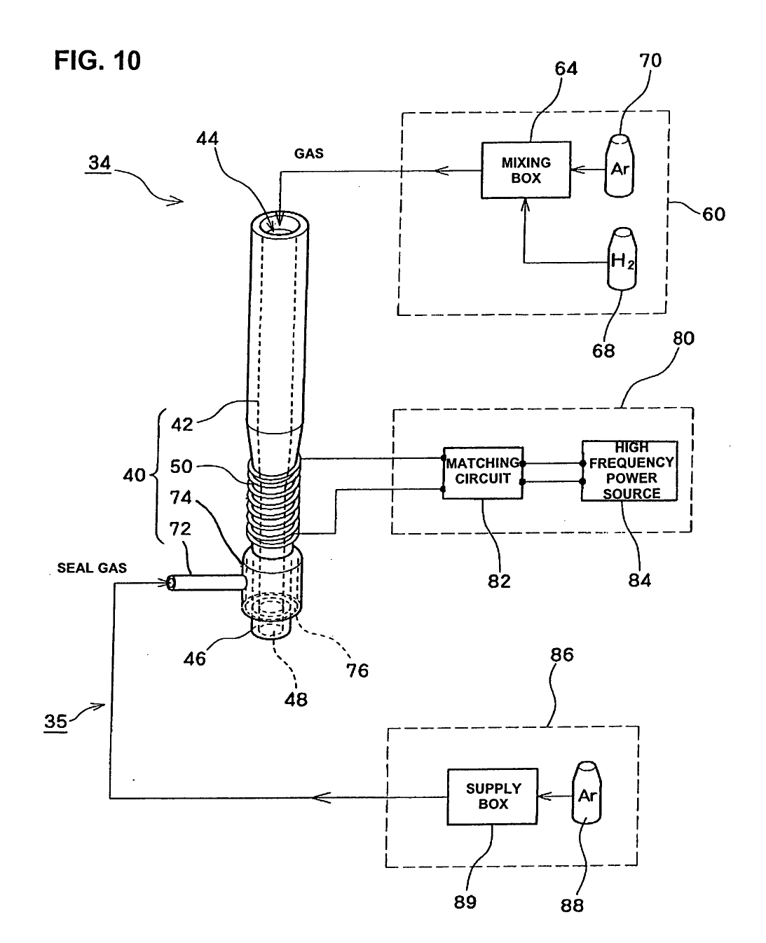

FIG. 10 illustrates the microplasma producing unit 34 and the seal gas spraying unit 35 of a different embodiment. The microplasma producing unit 34 includes, similarly to the embodiment shown in FIGS. 3 and 4, the plasma capillary 40 provided at the tip end of the plasma arm 31, the gas supply unit 60 connected to the plasma capillary 40, the high frequency power supply unit 80, and the seal gas supply unit 86. The seal gas spraying unit 35 includes the seal gas nozzle 74 provided at the tip end of the plasma capillary 40 and the seal gas supply unit 86. Below, the like components as shown in FIGS. 3 and 4 are indicated by the like numerals, and an explanation for these components is omitted.

As shown in FIG. 10, the plasma capillary 40 includes the tubular plasma capillary main body 42 made of an insulating body, a high frequency coil 50 that is wound around the plasma capillary main body 42, and the seal gas nozzle 74 provided at the outer circumference of the tip end portion 46 of the plasma capillary main body 42.

The plasma capillary main body 42 includes the gas supply outlet 44 for plasma that supplies the gas as a source of the microplasma, and has the same size and the same shape as the bonding capillary 24 other than the portion at which the high frequency coil 50 is wound about. An example of the size is: approximately 11 mm in length, approximately 1.6 mm in diameter at the thick portion, approximately 0.8 mm in diameter on a gas supplying side of the gas supply outlet 44 for plasma, approximately 0.05 mm in diameter at the tip end portion of the opening 48. Ceramics such as alumina can be also used as the material as in the bonding capillary 24.

The high frequency coil 50 that is wound about the plasma capillary main body 42 is a conducting wire with a couple turns. Although not shown in FIG. 10, an ignition equipment for plasma ignition is provided in the vicinity of the high frequency coil.

The high frequency power supply unit 80 serves to supply high frequency power for continuing the production of the microplasma to the high frequency coil 50 wound about the plasma capillary 40. The high frequency power supply unit 80 includes the matching circuit 82 and the high frequency power source 84. The matching circuit 82 is the circuit for suppressing power reflection when supplying high frequency power to the high frequency coil 50. As the matching circuit 82, a circuit constituting an LC resonator between the matching circuit 82 and the high frequency coil 50 is used, for example. As the high frequency power source 84, such a power source with a frequency of, for instance, 13.56 MHz, 100 MHz, or 450 MHz is used. Magnitude of power to be supplied is determined considering the flow rate of the gas supplied from the gas supply unit 60 and stability of the microplasma. The high frequency power source 84 is controlled under the control unit 90. The gas supply unit 60 and the seal gas supply unit 86 are the same as those described in the embodiment shown in FIGS. 3 and 4.

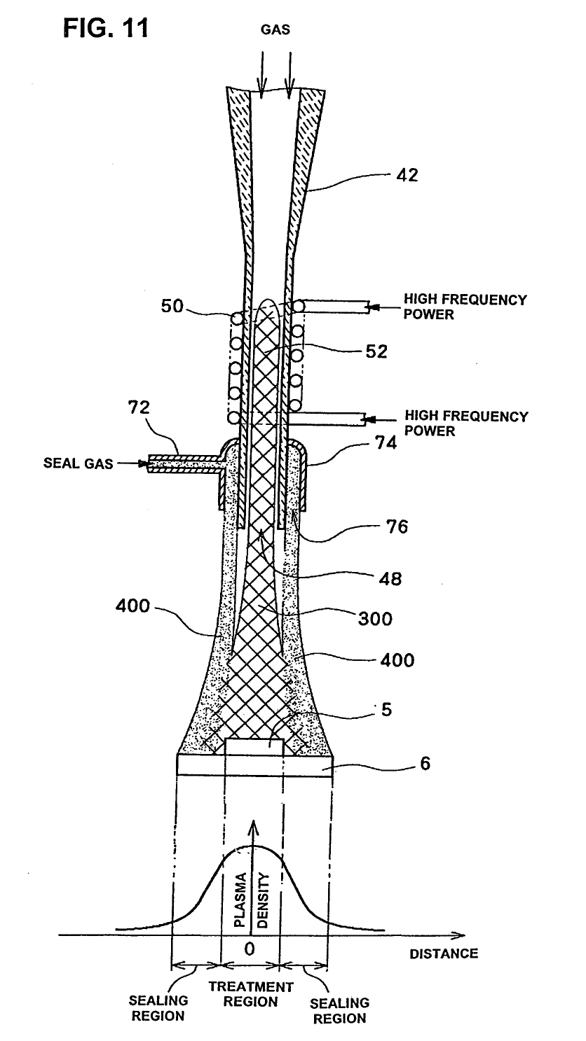

FIG. 11 is an illustration showing, as an effect of the microplasma producing unit 34 and the seal gas spraying unit 35, how the microplasma 300 produced in the plasma capillary 40 (see FIG. 10) and the seal gas sprayed from the annular opening 76 at the tip end of the seal gas nozzle 74 are irradiated to the bonding pad 5 of the semiconductor chip 6.

The following procedures are performed in order to produce the microplasma 300. First, the gas supply unit 60 is controlled to supply the gas of an appropriate flow rate to the gas supply outlet 44 for plasma (see FIG. 10) of the plasma capillary 40. The supplied gas flows outside from the opening 48 of the tip end portion. Next, the high frequency power supply unit 80 (see FIG. 10) is controlled to supply appropriate high frequency power to the high frequency coil 50. The above-described appropriate conditions can be obtained previously by experiments. Then, when the conditions for the supplied gas and for the high frequency power are both appropriate, the microplasma 300 is produced in the flowing gas due to the high frequency power. The plasma region 52 where the supplied gas is formed into plasma state gas inside the plasma capillary main body 42 is approximately positioned downstream of the gas from the position where the upper end of the high frequency coil 50 is located. The produced microplasma 300 is sprayed from the main body opening 48 at the tip end of the plasma capillary 40 and flows toward the bonding pad 5 as the microplasma spreads.

On the other hand, in order to produce the flow of the seal gas, first, the seal gas supply unit 86 (see FIG. 10) is controlled to supply the seal gas of an appropriate flow rate to the seal gas supply pipe 72 of the plasma capillary 40. The supplied seal gas flows through the annular flow channel within the seal gas nozzle 74 and is sprayed from the annular opening 76 at the tip end as the annular seal gas flow 400. The sprayed seal gas flow 400 flows toward the bonding pad 5 while the width of the flow channel becomes wider in a manner such that the outer diameter of the annular cross-section becomes greater and the inner diameter becomes smaller. Then, the seal gas is brought into contact with the outer circumference portion of the microplasma 300 between the main body opening 48 of the plasma capillary 40 and the bonding pad 5, and an integral flow in which the seal gas flow 400 surrounds the microplasma 300 is formed and reaches the bonding pad 5.

As can be seen from the graph shown in the lower part of FIG. 11, plasma density is high in the central portion of this integral gas flow because the seal gas does not come inside the gas flow, and gradually decreases toward the peripheral portion since the seal gas flow 400 and the microplasma 300 are mixed. At the outer circumference at which the integral flow is brought into contact with the ambient air, only the seal gas flows. Such a seal gas flow prevents the oxygen component and/or contamination in the ambient air from being mixed into the microplasma 300. The bonding pad 5 is, as a result, brought into contact with the central portion with high plasma density, and thus the removal process of removing such as the oxide film on the surface of the bonding pad 5 is performed.

The operation and effects of the bonding apparatus 10 that uses the plasma capillary 40 according to this embodiment are the same as those described in the above embodiments.

### SIXTH EMBODIMENT

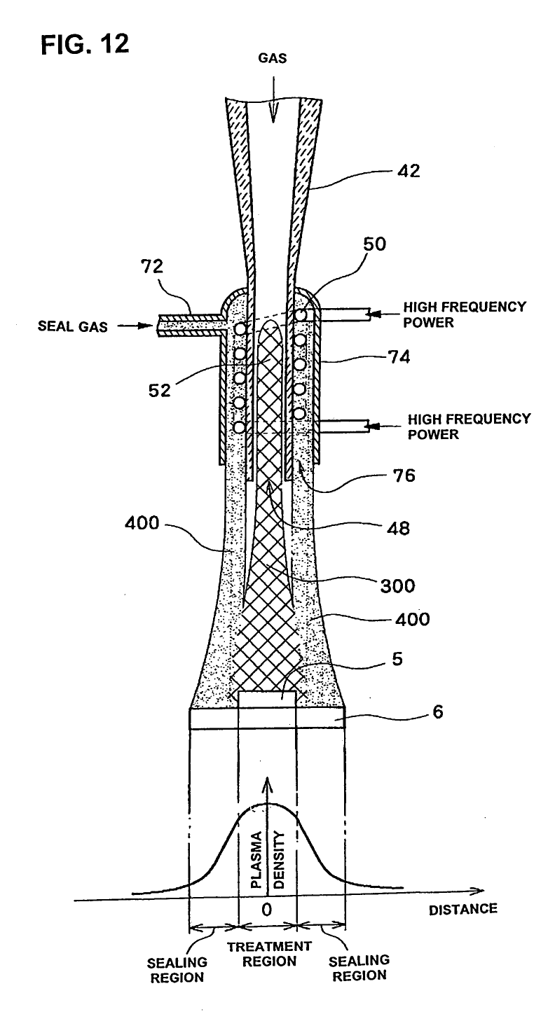

FIG. 12 illustrates a different embodiment of the plasma capillary 40 shown in FIG. 11. The like components as in the embodiment of the plasma capillary shown in FIG. 11 are indicated by the like numerals, and an explanation for these components is omitted.

As shown in FIG. 12, in the plasma capillary 40 of this embodiment, the high frequency coil 50 for producing plasma and the seal gas nozzle 74 are positioned in parallel along a direction of the gas flow. As shown in FIG. 12, the seal gas nozzle 74 is fixed to the plasma capillary main body 42 on the upstream side from the high frequency coil 50. The cylindrical seal gas nozzle 74 is provided outside of the high frequency coil 50 attached to the outer surface of the plasma capillary main body 42. A power feeder to the high frequency coil 50 is penetrating through the seal gas nozzle 74. As a result, the high frequency coil 50 is positioned in the annular channel between the seal gas nozzle 74 and the plasma capillary main body 42, which causes an entire length shorter. In addition, the distance from lower ends of the high frequency coil 50 to the main body opening 48 becomes shorter, and therefore the plasma intensity at the main body opening 48 can be maintained high. In this embodiment, it is preferable to make the tip end to be tapered in a nozzle shape when it is desired to increase the flow rate of the seal gas flow 400 sprayed from the annular opening 76.

The operation and effects of the bonding apparatus 10 using the plasma capillary 40 according to this embodiment are the same as those described in the above embodiments.

### SEVENTH EMBODIMENT

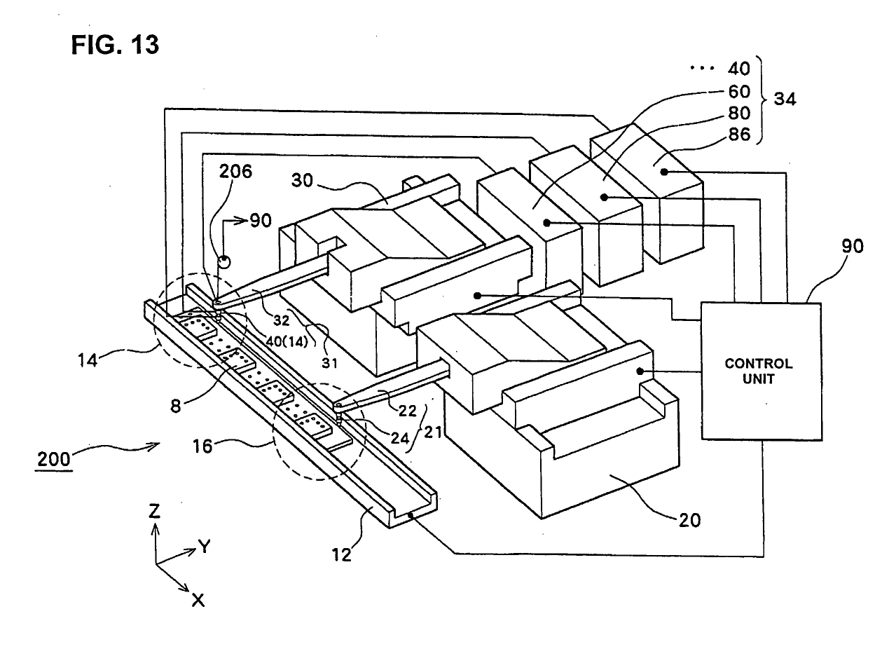

FIG. 13 illustrates, as a different embodiment, a wire bonding apparatus 200 capable of a performing surface treatment and a bonding process. The like components as in the wire bonding apparatus 10 shown in FIG. 1 are indicated by the like numerals, and an explanation for these components is omitted. The semiconductor chip that is the object to be bonded 8 mounted on the substrate is also illustrated in FIG. 13, although the semiconductor chip is not a component of the wire bonding apparatus 200. The wire bonding apparatus 200 serves for performing the surface treatment by an effect of plasma state gas, prior to the bonding, to the object to be bonded 8 at small regions at which the wire is bonded, specifically, a bonding pad of the semiconductor chip and a bonding lead on the substrate, and then performing the bonding process.

More specifically, as the surface treatment to the bonding pad and the bonding lead, the wire bonding apparatus 200 performs the removal of an oxide film, contamination, foreign substances, or such on the surface of the bonding pad or the bonding lead, and then performs the deposition of the same material as the bonding wire on the surface of the bonding pad or the bonding lead. The wire bonding apparatus 200 further serves for bonding the bonding wire to the bonding pad and the bonding lead to which the removal and deposition processes are performed. A thin wire made of, for instance, gold and aluminum can be used as the bonding wire.

The wire bonding apparatus 200 is configured such that the wire bonding apparatus 10 shown in FIG. 1 further includes a position change unit 206 that changes a position of the bonding wire that is inserted through the plasma capillary 40. The position change unit 206 is connected to the control unit 90.

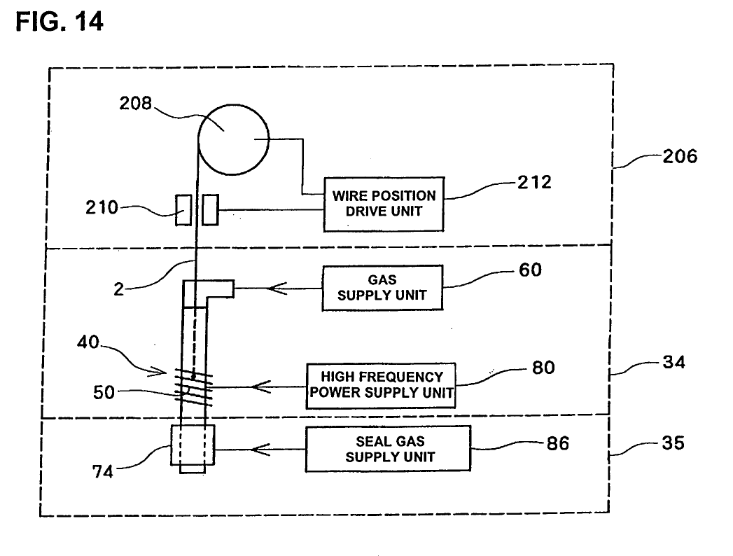

FIG. 14 is an illustration by extracting component parts relating to the surface treatment including the position change unit 206. Each component relating to the surface treatment roughly belongs to one of the followings: the microplasma producing unit 34 for producing the microplasma for surface treatment within the plasma capillary 40 and spraying the produced microplasma from the tip end opening to irradiate to the object to be bonded; the seal gas spraying unit 35 for spraying the seal gas so as to enclose the sprayed microplasma to seal the microplasma from the ambient air; and the position change unit 206 for changing positional relation from the plasma region where the microplasma is produced and a tip end of a bonding wire 2.

The position change unit 206 includes a spool 208 that feeds the bonding wire 2, a clamper 210 that clamps or releases the bonding wire 2, and a wire position drive unit 212 that rotates the spool 208, and switches between open and close of the clamper 210. An operational instruction to the wire position drive unit 212 is given under the control of the control unit 90 (see FIG. 13). Such as a rotational direction (forward or backward) and a rotational quantum of the spool 208, and timing of opening and closing the clamper 210 are controlled according to the instruction from the control unit 90, and thus a position of the tip end of the bonding wire 2 is moved upward and downward within the plasma capillary 40.

The microplasma producing unit 34 has the same configuration as the configuration in which the high frequency coil 50 for producing plasma is provided to the outer surface near the tip end of the plasma capillary main body 42 as described referring to FIG. 10.

Further, the seal gas spraying unit 35 also has the same configuration as described referring to FIG. 10.

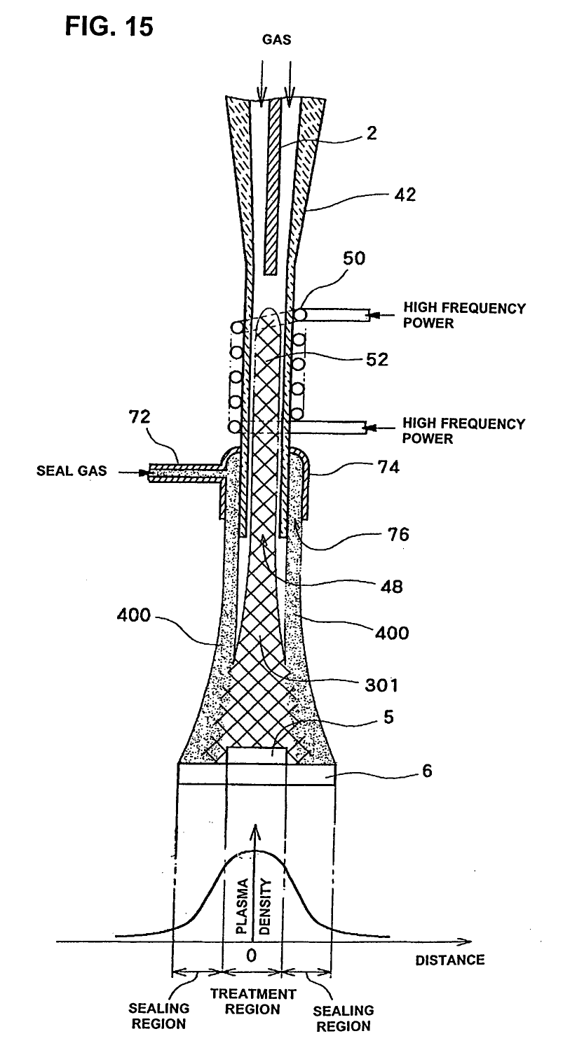

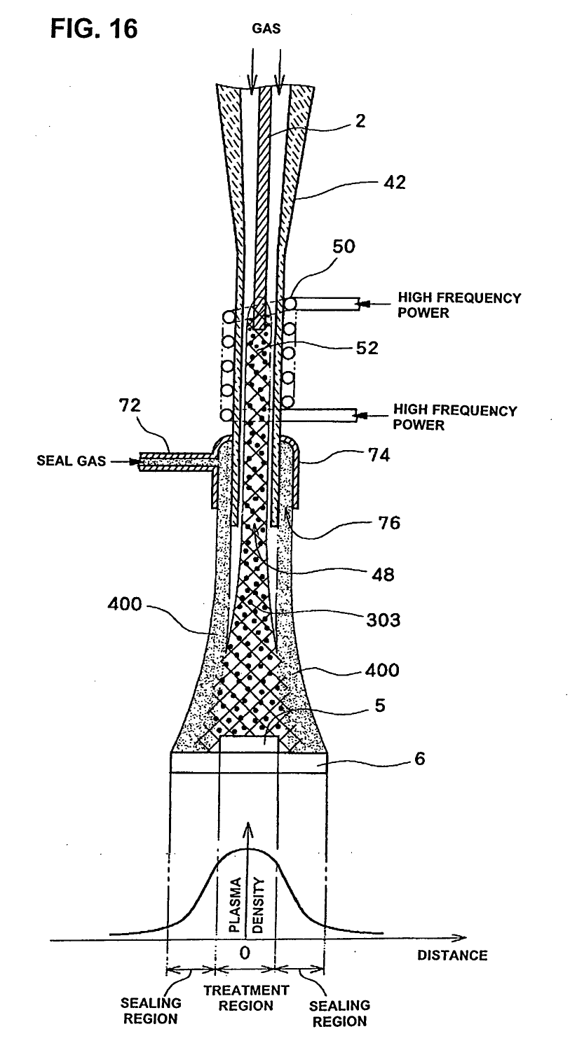

FIGS. 15 and 16 are illustrations respectively showing, as an effect of the microplasma producing unit 34 and the seal gas spraying unit 35, how the microplasma 301 and microplasma 303 both produced within the plasma capillary 40 and the seal gas sprayed from the annular opening 76 at the tip end of the seal gas nozzle 74 are irradiated to the bonding pad 5 of the semiconductor chip 6. FIG. 15 shows how the reducing microplasma 301 is produced in the removal process for removing the oxide film or such on the surface, and FIG. 16 shows how the microplasma 303 is produced in the deposition process. The microplasma 303 includes fine particles of sputtered material for the bonding wire 2, for example, fine particles of sputtered gold.

The following procedures are performed in order to produce the reducing microplasma 301. First, the gas supply unit 60 (see FIG. 14) is controlled to supply a gas of an appropriate flow rate to the gas supply outlet 44 of the plasma capillary 40. The supplied gas flows out of the plasma capillary 40 from the main body opening 48 of the tip end portion. Next, the high frequency power supply unit 80 (see FIG. 14) is controlled to supply appropriate high frequency power to the high frequency coil 50. The above-described appropriate conditions of the gas flow rate and high frequency power can be obtained previously by experiments. Then, when the conditions for the supplied gas and for the high frequency power are both appropriate, the reducing microplasma 301 is produced in the flowing gas due to the high frequency power. The plasma region 52 where the supplied gas is formed into plasma state gas inside the plasma capillary main body 42 is approximately positioned downstream of the gas from a position where the upper end of the high frequency coil 50 is located. The produced reducing microplasma 301 is sprayed from the main body opening 48 at the tip end of the plasma capillary 40 and flows toward the bonding pad 5 as the microplasma spreads.

On the other hand, in order to produce the flow of the seal gas, first, the seal gas supply unit 86 (see FIG. 14) is controlled to supply the seal gas of an appropriate flow rate to the seal gas supply pipe 72 of the plasma capillary 40. The supplied seal gas flows through the annular flow channel within the seal gas nozzle 74 and is sprayed from the annular opening 76 at the tip end as the annular seal gas flow 400. The sprayed seal gas flow 400 flows toward the bonding pad 5 while the width of the flow channel becomes wider in a manner such that the outer diameter of the annular cross-section becomes greater and the inner diameter becomes smaller. Then, the seal gas is brought into contact with the outer circumference portion of the reducing microplasma 301 between the main body opening 48 of the plasma capillary 40 and the bonding pad 5, and an integral flow in which the seal gas flow 400 surrounds the reducing microplasma 301 is formed and reaches the bonding pad 5.

As can be seen from the graph shown in the lower part of FIG. 15, plasma density is high in central portion of this integral gas flow because the seal gas does not come inside the gas flow, and gradually decreases toward the peripheral portion since the seal gas flow 400 and the reducing microplasma 301 are mixed. At the outer circumference at which the integral flow is brought into contact with the ambient air, only the seal gas flows. Such a seal gas flow prevents the oxygen component and/or contamination in the ambient air from being mixed into the reducing microplasma 301. The bonding pad 5 is, as a result, brought into contact with the central portion with high plasma density, and thus the removal process of removing such as the oxide film on the surface of the bonding pad 5 is performed.

On the other hand, when performing the deposition process, as shown in FIG. 16, the bonding wire 2 is inserted into the plasma capillary 40 so that the tip end of the wire is positioned at the plasma region 52 by the position change unit 206. Further, when the bonding wire 2 is, for example, a gold wire, the material for the bonding wire 2 is turned into fine particles by the reducing microplasma 301 in the plasma region 52, and the microplasma 303 including sputtered gold fine particles is sprayed from the main body opening 48 at the tip end portion so that the gold of the same material as the bonding wire 2 is deposited on the surface of the object to be bonded. At this time, similarly to the removal process for removing oxides and such on the surface, the seal gas flow 400 on the surface is sprayed from the annular opening 76 to prevent the deposited gold from being oxidized by an oxygen component and such in the ambient air or from being mixed with contamination in the ambient air and deposited in combination.

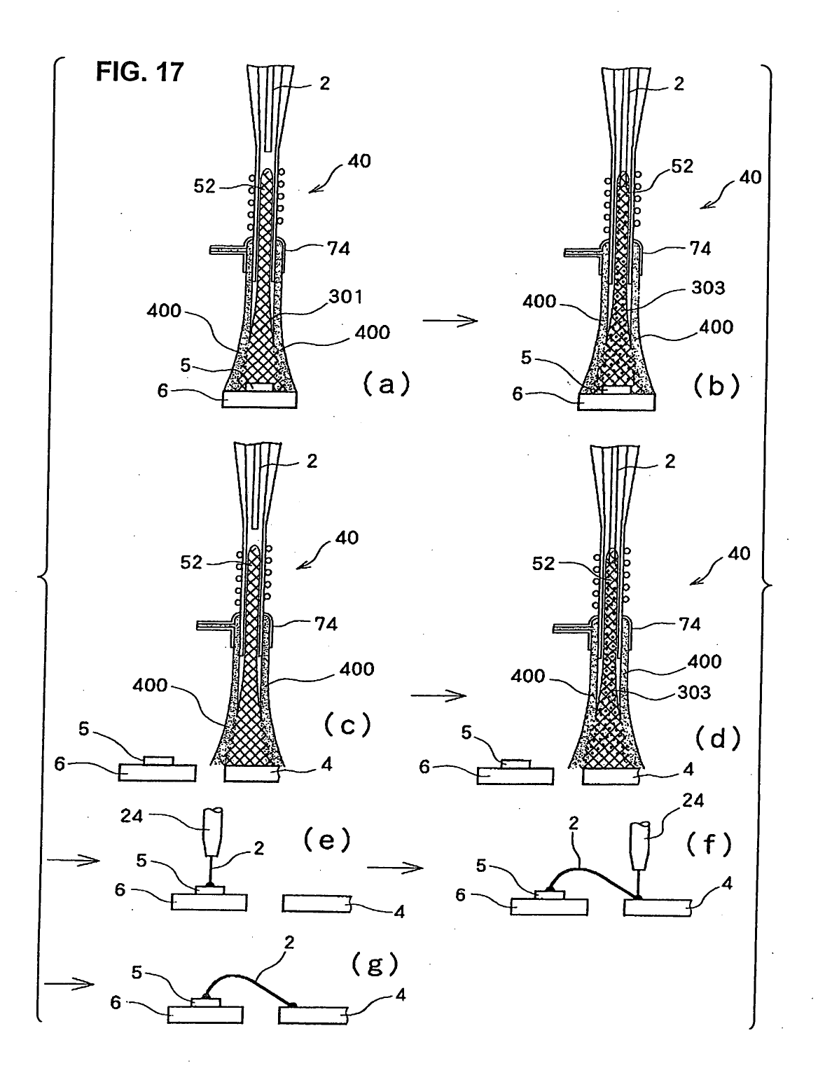

An operation of the wire bonding apparatus 100 configured as above will be described referring to FIG. 17. FIG. 17 shows procedures for the surface treatment including the removal process and the deposition process of the surface that is performed in conjunction with the bonding process.

In order to perform the wire bonding, first, the wire bonding apparatus 100 (see FIG. 13) is activated to transfer the object to be bonded 8 to the stage 14 for surface treatment using the transfer mechanism 12, and positions the object to be bonded 8 (surface treatment positioning step).

Then, according to an instruction from the control unit 90, the microplasma producing unit 34 is activated, and the microplasma is produced at the plasma capillary 40. Prior to this operation, the bonding wire 2 is pulled up at a sufficiently high position in the plasma capillary 40 by a function of the position change unit 206 (see FIG. 14). The type of the gas is limited to the carrier gas, and mixing of the gas for surface treatment is not need to be mixed yet. At this time, the plasma capillary 40 stays away from the object to be bonded 8, and the microplasma has no effect to the object to be bonded 8 (microplasma producing step).

Next, when the wire bonding program is run, positioning is performed on the stage 14 for surface treatment in a similar manner as the case of the stage 16 for bonding, and the plasma capillary 40 is moved immediately and high above the first one of the bonding pads 5 (bonding pad positioning step).

Then, according to an instruction from the control unit 90, the reducing gas, i.e. hydrogen, is selected and mixed into the carrier gas to make the microplasma into the reducing microplasma 301 (microplasma setting step).

The wire bonding program then causes the plasma capillary 40 to be move down toward the bonding pad 5. At this time, the position of the tip end of the plasma capillary 40 is previously offset to the tip end of the bonding capillary by the height in the range within which the reducing microplasma 301 and the seal gas flow 400 have an effect. By this, when the wire bonding program causes the first bonding to be executed, the tip end of the plasma capillary 40 is positioned right above the bonding pad 5 at a height at which the integral gas flow of the reducing microplasma 301 and the seal gas flow 400 is irradiated to the bonding pad 5 in an optimal manner to seal the ambient air. At this point, the integral gas flow of the reducing microplasma 301 and the seal gas flow 400 removes the thin oxide film on the surface of the bonding pad 5 in an atmosphere in which the reducing microplasma 301 is sealed from the ambient air to obtain a clean surface (bonding pad surface treatment step). Illustration (a) of FIG. 17 shows how the above operation is performed.

Next, the control unit 90 gives an instruction to the position change unit 206 and has the position change unit 206 change the position of the tip end of the bonding wire 2 so that the tip end of the bonding wire 2 is inserted in the plasma region 52 of the plasma capillary 40. Here, if the bonding wire 2 is a thin gold wire, then because the microplasma is a reducing atmosphere, the portion of the bonding wire 2 that has been inserted through the plasma region 52 is turned into fine particles under an effect of the reducing microplasma 301. Subsequently, the microplasma 303 including the fine particles of the sputtered gold is irradiated toward the bonding pad 5, and thus, the material that is the same as the bonding wire 2 is deposited on the clean surface of the bonding pad 5 to form a thin gold film. At this time, the perimeter of the microplasma 303 is sealed from the ambient air by the seal gas flow 400 (bonding pad surface deposition process step). Illustration (b) of FIG. 17 shows how the above operation is performed.

Next, the wire bonding program causes the plasma capillary 40 to be pulled upward and then moved immediately above the bonding lead 4 (bonding lead positioning step). Prior to this operation, the control unit 90 gives an instruction to the position change unit 206 and has the position change unit 206 change the position of the tip end of the bonding wire 2 so that the tip end of the bonding wire 2 is positioned outside of the plasma region 52 of the plasma capillary 40.

The wire bonding program then causes the plasma capillary 40 to be moved down toward the bonding lead 4. Subsequently, the tip end of the plasma capillary 40 is positioned right above the bonding lead 4 at a height at which the integral gas flow of the reducing microplasma 301 and the seal gas flow 400 is irradiated to the bonding lead 4 in an optimal manner to seal the ambient air. At this point, the integral gas flow of the reducing microplasma 301 and the seal gas flow 400 removes such as contamination and/or foreign substances on the surface of the bonding lead 4 in an atmosphere in which the reducing microplasma 301 is sealed from the ambient air to obtain a clean surface (bonding lead surface treatment step). Illustration (c) of FIG. 17 shows how the above operation is performed.

Next, the control unit 90 gives an instruction to the position change unit 206 and has the position change unit 206 change the position of the tip end of the bonding wire 2 so that the tip end of the bonding wire 2 is inserted in the plasma region 52 of the plasma capillary 40. Because the microplasma is reducing atmosphere, the portion of the bonding wire 2 that has been inserted through the plasma region 52 is turned into fine particles under an effect of the reducing microplasma 301. Subsequently, the microplasma 303 including the fine particles of the sputtered gold is irradiated toward the bonding lead 4, and thus, the material that is the same as the bonding wire 2 is deposited on the clean surface of the bonding lead 4 to form a thin gold film. At this time, the perimeter of the microplasma 303 is sealed from the ambient air by the seal gas flow 400 (bonding lead surface deposition process step). Illustration (d) of FIG. 17 shows how the above operation is performed.

Then, as the wire bonding program causes the operation to advance, the control unit 90 controls the microplasma producing unit 34 and the position change unit 206 to switch between the microplasma having a property for the removal process and a property for the deposition process, thereby proceeding the removal process and the deposition process to the surface of each bonding pad 5 and each bonding lead 4. Consequently, when the wire bonding program causes the operation to end, all of the bonding pads 5 and all of the bonding leads 4 of the object to be bonded 8 have gone through the removal process of such as the oxide film on the surface and the deposition process (surface treatment completing step).

Next, according to an instruction from the control unit 90, the transfer mechanism 12 (see FIG. 13) transfers the object to be bonded 8 that has gone through the surface treatment to the stage 16 for bonding, and positions the object to be bonded 8 (bonding process positioning step). Then, the wire bonding program is run, and the first bonding to the bonding pad 5 is performed by known method, and then the second bonding to the bonding lead 4 is performed (bonding process step). Illustrations (e) and (f) of FIG. 17 show how this operation is performed. While the bonding is thus being performed, for each bonding pad 5 and each bonding lead 4, the oxide film on the surface is removed and the material that is the same as the bonding wire 2 is deposited in a form of a thin film on the surface in a state being sealed from the ambient air. Consequently, the bonding process can be performed more stably. Illustration (g) of FIG. 17 shows how the bonding process is performed in this manner. After repeating this operation, when the wire bonding program causes the operation to end, the bonding process for all of the bonding pads 5 and all of the bonding leads 4 of the object to be bonded 8 is completed (bonding process completing step).

The above-described embodiment prevents the oxygen component and the contamination in the ambient air from being mixed into the reducing microplasma 301 by forming the integral flow such that the seal gas flow 400 surrounds the reducing microplasma 301 that then reaches the bonding pad 5 and the bonding lead 4 of the object to be bonded, and performs the removal process for removing the thin oxide film, the contamination, and/or the foreign substances from the surface of the bonding pad 5 or the bonding lead 4 of the object to be bonded by the central portion having high plasma density. In addition, the material that is the same as the bonding wire 2 can be deposited on the surface in a similar state in which the seal gas flows. As a result, it is possible to reduce the possibility of re-oxidation and/or re-contamination in the removal process and the deposition process using the microplasma, and realize effective surface treatment to the object to be bonded using the microplasma. Moreover, there is an advantage that the bonding process can be performed more stably by employing such effective surface treatment.

Further, this embodiment includes the microplasma producing unit 34 capable of spraying the microplasma 300 from the main body opening 48 at the tip end portion of the plasma capillary 40 and the seal gas spraying unit 35 capable of spraying the seal gas flow 400 from the annular opening 76 at the tip end of the plasma capillary 40. Accordingly, a single bonding apparatus is provided with the functions of irradiating the microplasma 301 and the seal gas flow 400 to a small region of the object to be bonded to perform the removal process and the deposition process with reduced damage, re-oxidation, and re-contamination, as well as of performing the bonding process. Therefore, there is an advantage that the effective surface treatment and the bonding process to the object to be bonded can be efficiently performed.

### Eighth Embodiment

Based on the wire bonding apparatus 200 shown in FIG. 13 that is a two-stage apparatus, a bump bonding apparatus can be configured. Specifically, in the wire bonding apparatus 200 shown in FIG. 13, the object to be bonded 8 transferred by the transfer mechanism 12 is replaced with a finished wafer on which completed LSIs are arranged.

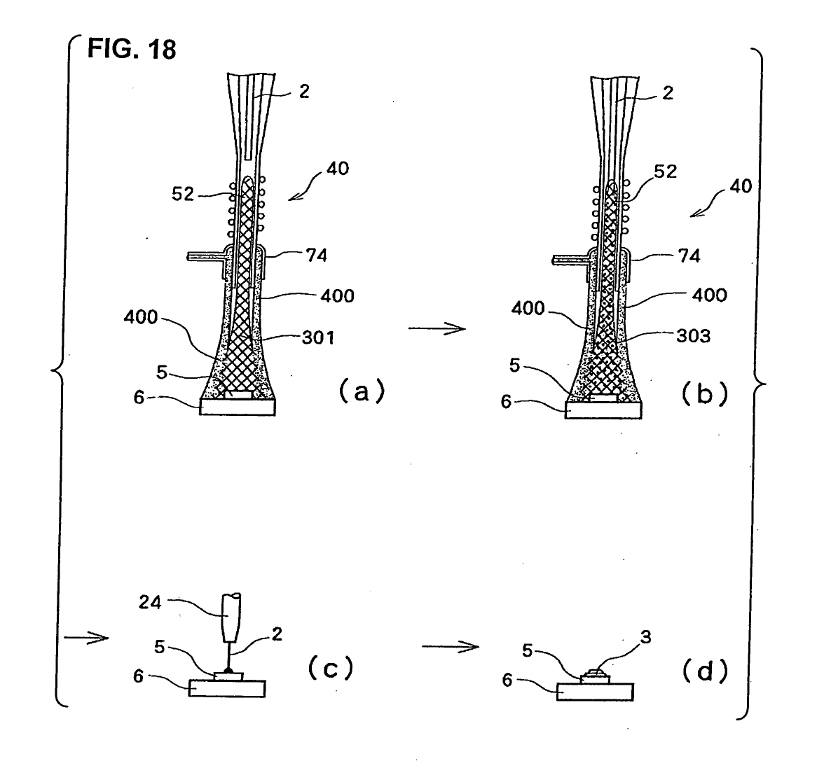

When a finished wafer is used as the object to be bonded 8, a series of processes including the removal process of the surface, the deposition process, and the bonding process are performed to the bonding pads 5 of each of a plurality of the completed LSIs on a stage 204 for bonding. An operation of the bump bonding apparatus that is configured by, except for the transfer mechanism 12, the same components in the same manner as in the wire bonding apparatus 200 shown in FIG. 13 is described referring to a process chart of FIG. 18.

In FIG. 18, Illustration (a) shows a step for removing the oxide film on the surface of the bonding pad 5 by the reducing microplasma 301, where the position of the tip end of the bonding wire 2 within the plasma capillary 40 is set to be outside of the plasma region 52. This step is the same as that described referring to Illustration (a) of FIG. 17.

Further, in FIG. 18, Illustration (b) shows a step for depositing the material that is the same as the bonding wire 2 on the surface of the bonding pad 5, where the bonding wire 2 is a thin gold wire and the position of the tip end of the bonding wire 2 within the plasma capillary 40 is set to be inside of the plasma region 52. This step is the same as that described referring to Illustration (b) of FIG. 17.

Below, as a bump bonding program causes the operation to advance, the removal process of the surface and the deposition process are sequentially performed to the bonding pad 5 at the position of each of the LSIs. Consequently, when the wire bonding program causes the operation to end, all of the bonding pads 5 of the object to be bonded 8 have gone through the removal process of the surface and the deposition process.

Next, according to an instruction from the control unit 90 (see FIG. 13), the transfer mechanism 12 transfers the finished wafer that has gone through the surface treatment to the stage 16 for bonding, and positions the finished wafer. Then, the bump bonding program is run, and the gold wire is bonded to form the gold bump on the first of the bonding pads 5 at the position of the first of the LSIs. Illustration (c) of FIG. 18 shows how this operation is performed. At this time, the oxide film on the surface of the bonding pad 5 has been previously removed and the thin gold film is deposited thereon, and therefore the bonding process can be performed more stably. Illustration (d) of FIG. 18 shows how the bonding process is completed and a gold bump 3 is formed in this manner. After repeating this operation, the gold bump 3 is formed on each of the bonding pads 5 of all of the LSIs on the single wafer.

The above-described embodiment, similarly to the previously explained embodiment, has the advantageous effects that the possibility of re-oxidation and/or re-contamination in the surface treatment can be reduced using the microplasma, and the effective surface treatment to the object to be bonded can be realized using the microplasma.

### NINTH EMBODIMENT

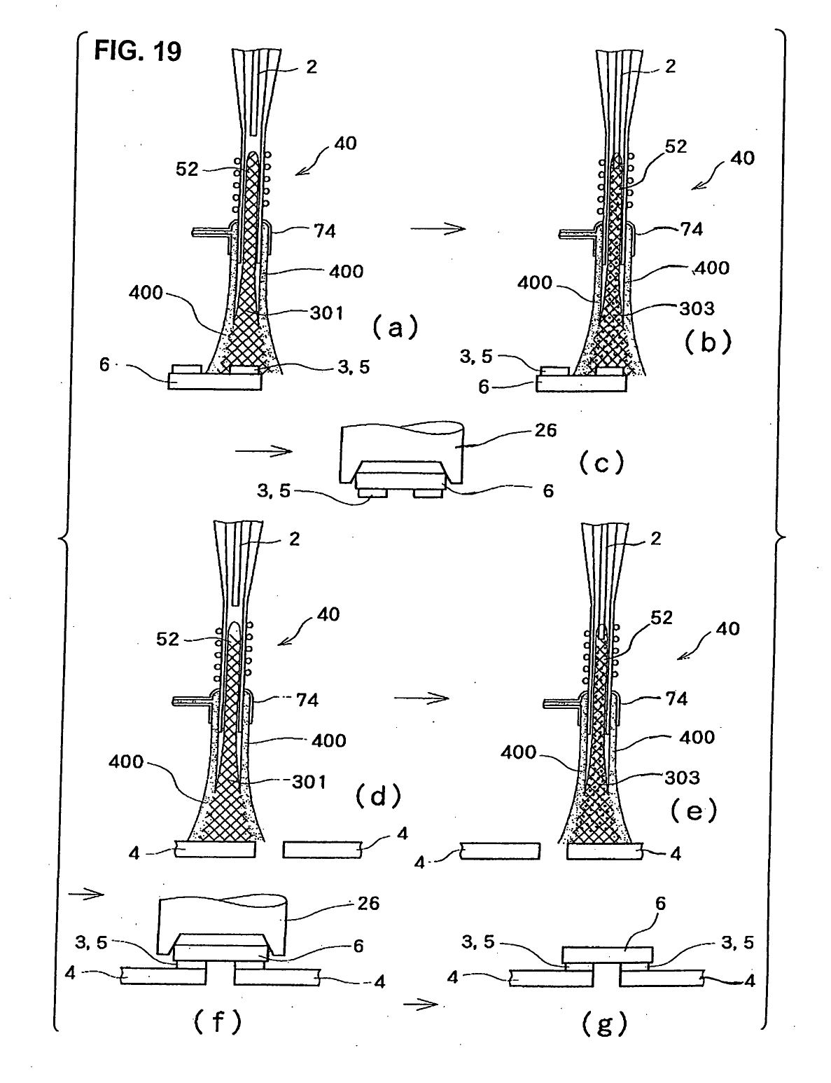

The position change unit 206, the microplasma producing unit 34, and the seal gas spraying unit 35 that are described in FIG. 14 can be applied to a flip chip bonding apparatus. The position change unit 206, the microplasma producing unit 34, and the seal gas spraying unit 35 are utilized in this flip chip bonding apparatus when the removal process of the surface and the deposition process are performed to the bump 3 of the chip before the chip is flipped over and held by the collet, and when the removal process of the surface and the deposition process are performed to the bonding lead 4 before the face down bonding is performed using the collet. FIG. 19 illustrates procedures for utilizing the position change unit 206 and the microplasma producing unit 34 in the flip chip bonding apparatus.

Illustration (a) of FIG. 19 shows a step for cleaning the surface of the gold bump 3 on the bonding pad 5 by performing the removing process to the surface of the bump 3. Other than that the position of the tip end of the bonding wire 2 within the plasma capillary 40 is set to be outside of the plasma region 52, and that an object to be irradiated is now the gold bump 3, this step is the same as that described referring to Illustration (a) of FIG. 17.

Further, Illustration (b) of FIG. 19 shows a step for depositing the material that is the same as the bonding wire 2 on the surface of the gold bump 3 that has been cleaned by the reducing microplasma 301, where the bonding wire 2 is a thin gold wire and the position of the tip end of the bonding wire 2 within the plasma capillary 40 is set to be inside the plasma region 52. This step is also the same as that described referring to Illustration (b) of FIG. 17, other than that the object to be irradiated is now the gold bump 3.

Then, the semiconductor chip 6 of which the removal process of the surface and the deposition process are performed to all bumps 3 is flipped over, and held by a collet 26 in a face down state. The face down state refers to the state in which the bump 3 faces downward. The collet 26 can hold the semiconductor chip 6 by vacuum suction. Illustration (c) of FIG. 19 shows how this operation is performed.

Next, the surface treatment is performed to the bonding lead 4 of the circuit board in the same manner as described above. Illustration (d) of FIG. 19 shows a step for performing the removal process of the surface of the bonding lead 4, where the position of the tip end of the bonding wire 2 within the plasma capillary 40 is set to be outside of the plasma region 52. This step is the same as that described referring to Illustration (c) of FIG. 17.

Further, Illustration (d) of FIG. 19 shows a step for depositing the material that is the same as the bonding wire 2 on the surface of the bonding lead 4 by the reducing microplasma 301, where the position of the tip end of the bonding wire 2 within the plasma capillary 40 is set to be inside of the plasma region 52. This step is the same as that described referring to Illustration (d) of FIG. 17.

Then, the semiconductor chip 6 held in the face down state is positioned with respect to the bonding lead 4, to perform the face down bonding. Illustration (f) of FIG. 19 shows how this operation is performed. Illustration (g) of FIG. 19 shows how the bump 3 on the semiconductor chip 6 is bonded to the bonding lead 4.

The above-described embodiment, similarly to the previously explained embodiments, has the advantageous effects that the possibility of re-oxidation and/or re-contamination in the surface treatment can be reduced using the microplasma, and the effective surface treatment to the object to be bonded can be realized using the microplasma.

### TENTH EMBODIMENT

In the above described embodiments, the stage for surface treatment and the stage for bonding are separately provided, for which the XYZ drive mechanism for surface treatment and the XYZ drive mechanism for bonding are respectively used, and the plasma arm and the bonding arm are operated in conjunction with each other, that is, the plasma capillary and the bonding capillary are operated in conjunction with each other. Specifically, the surface treatment and the bonding process are performed in parallel for different pieces of the same type of the objects to be bonded.

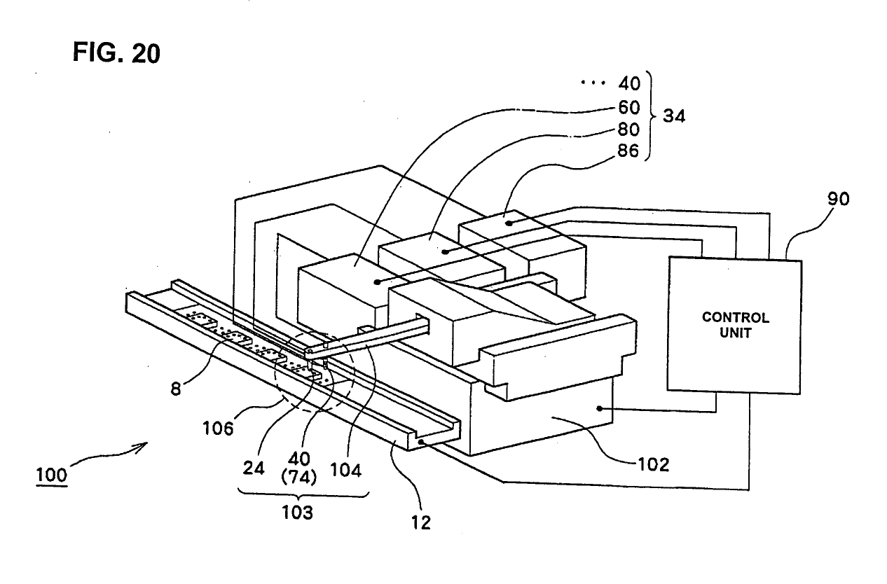

In contrast, it is possible to perform the surface treatment and the bonding process in conjunction with each other to the same piece of the object to be bonded on the same treatment stage. FIG. 20 shows a configuration of a single-stage wire bonding apparatus 100 provided with a single XYZ drive mechanism 102, a single arm 103, and a single treatment stage 106. To compare with this type of apparatus of FIG. 20, the wire bonding apparatus 10 shown in FIG. 1 can be called a two-stage apparatus. In the following, the like components as in FIG. 1 are indicated by the like numerals, and a detailed explanation for these components is omitted.

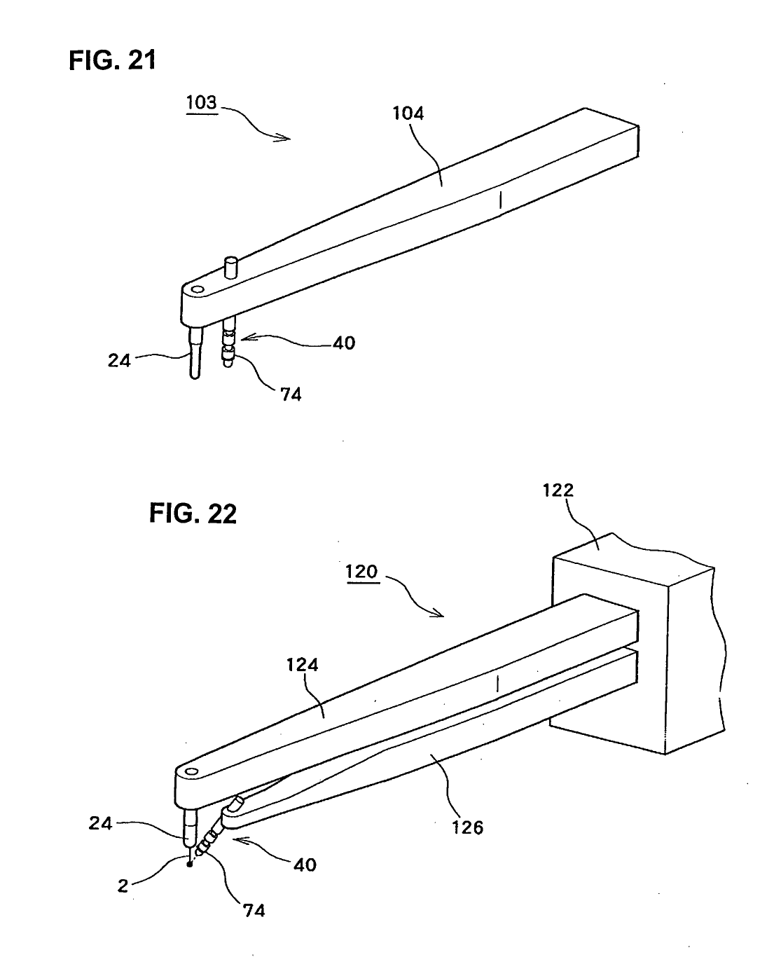

In the single-stage wire bonding apparatus 100, a single arm main body 104 of the arm 103 is provided with both of the bonding capillary 24 and the plasma capillary 40. FIG. 20 shows such a configuration (see FIG. 21 also). Here, a configuration, in which the microplasma producing unit 34 is comprised of the plasma capillary 40, the gas supply unit 60, and the high frequency power supply unit 80, and the seal gas spraying unit 35 is comprised of the seal gas nozzle 74 provided at the tip end of the plasma capillary 40 and the seal gas supply unit 86, is the same as that described referring to FIG. 3 and FIG. 10, and the operation of these units is also the same as that described referring to FIG. 3 and FIG. 10.

As shown in FIG. 21, since the bonding capillary 24 and the plasma capillary 40 are provided in the single arm 103, only one XYZ drive mechanism is necessary, which makes the configuration simple. Procedures of the surface treatment and the bonding process in this case can be typically performed sequentially and alternately. For example, the surface treatment to the bonding pad is performed by positioning the plasma capillary 40 to a single bonding pad, and then the arm 103 is moved to position the plasma capillary 40 to the corresponding bonding lead to perform the surface treatment to the bonding lead. In this manner, upon completion of the surface treatment to a single pair of the bonding pad and the bonding lead, the arm 103 is moved to position the bonding capillary 24 at the bonding pad and the first bonding of the wire is performed. Subsequently, the position of the bonding capillary 24 is moved to the bonding lead to perform the second bonding.

In other words, the procedures shown by Illustrations of (a) to (e) in FIG. 6 and described with reference to the two-stage wire bonding apparatus 10 are repeated. In these procedures, the surface treatment and the bonding process are alternately performed, such as the surface treatment, the bonding process, the surface treatment, the bonding process, and so on. These procedures are performed sequentially to each pair of the bonding pad and the bonding lead. This method enables the bonding with a reduced time period after the surface treatment till the bonding process for the bonding pad and the bonding lead, and the method also enables the bonding with reduced possibility for the oxide film and/or the foreign substances to attach to the surface again after the surface treatment.

In the configuration shown in FIG. 21, the arm main body 104 is provided with the bonding capillary 24 and the plasma capillary 40 that are close to each other in parallel. Driving and moving of the arm 103 becomes simpler by providing the plasma capillary 40 to form an angle with respect to the bonding capillary 24 so that a direction to which the bonding capillary 24 faces and a direction to which the plasma capillary 40 faces substantially coincide. In other words, without moving the arm 103, the microplasma is irradiated by the plasma capillary 40 to the same bonding pad and the same bonding lead to perform the surface treatment, and then the production of the microplasma is stopped and the wire is bonded using the bonding capillary 24.

In the structure of FIG. 21, the arm main body 104 is provided with the bonding capillary 24 and the plasma capillary 40. Accordingly, when the arm main body 104 also serves as a horn, for example, for better transmission of the ultrasonic energy to the tip end, energy transmission efficiency of the horn can not become optimal due to the presence of the plasma capillary 40. Therefore, an application of the wire bonding apparatus having the configuration shown in FIG. 21 is preferred for a technique that uses thermocompression bonding, for example, and not for the technique that uses the ultrasonic energy. Further, it is possible to apply the configuration shown in FIG. 21 to an apparatus in which the thermocompression bonding is assisted by the ultrasonic energy.

FIG. 22 shows an example of another configuration of the arm of the single-stage wire bonding apparatus. In an arm 120 in this apparatus, a bonding arm main body 124 for the bonding capillary 24 and a plasma arm main body 126 for the plasma capillary 40 are provided separately so as not to interfere each other, with a base portion 122 in common. The base portion 122 is attached to the common XYZ drive mechanism.

According to the configuration shown in FIG. 22, even with a bonding apparatus that performs the bonding process mainly using the ultrasonic energy, it is possible to reduce the influence of the plasma capillary 40 and to set a shape of the bonding arm main body 124 in an optimal manner.

It should be noted that, in FIG. 22, an example is shown in which the plasma capillary 40 is provided to form an angle with respect to the bonding capillary 24, so that the direction to which the bonding capillary 24 faces and the direction to which the plasma capillary 40 faces substantially coincide. With such a configuration, the driving and moving of the arm 120 can be simpler, as described above. It should be understood that the bonding capillary 24 and the plasma capillary 40 can be provided in parallel without any angle with reference to each other.

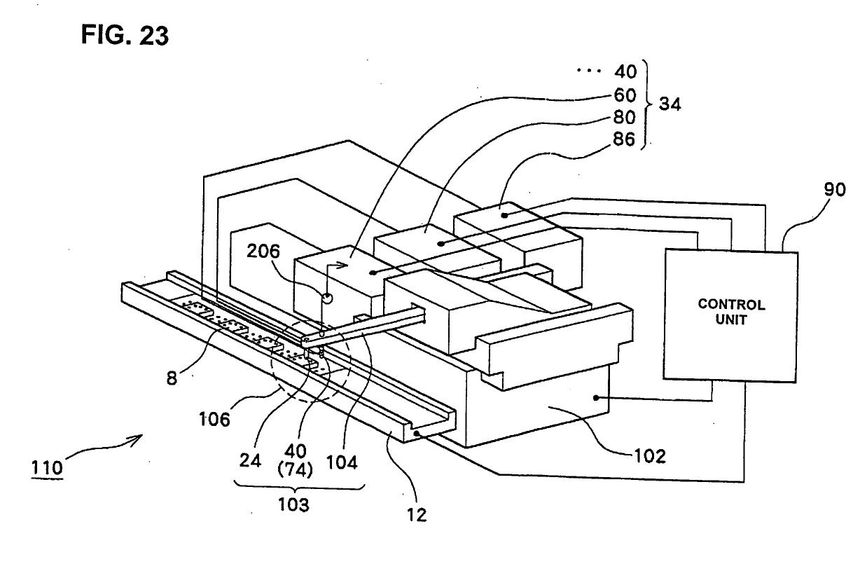

Further, as shown in FIG. 23, a wire bonding apparatus 110 can be provided in such a manner that the plasma capillary 40 of the wire bonding apparatus 100 described referring to FIG. 20 further includes the position change unit 206 for a wire, the position change unit 206 is connected to the control unit 90, and the material that is the same as the bonding wire is deposited on the surface of the object to be bonded after the removal process for removing the oxide film and such on the surface of the object to be bonded.

In this embodiment, in addition to the above-described embodiments, the bonding process and the surface treatment are performed in conjunction with each other to the same object to be bonded. Accordingly, there is an advantageous effect that the surface treatment and the bonding process are performed to a single chip simultaneously in parallel, for example, or sequentially, and the bonding process can be performed immediately after the surface treatment. Moreover, there is another effect that the transfer mechanism can be simpler in structure and operation because the bonding arm and the plasma arm can be moved integrally.

What is claimed is:

1. A bonding apparatus comprising:
a bonding process unit capable of performing a bonding process to an object to be bonded using a bonding tool; and
a plasma capillary that includes a plasma producing unit and a seal gas spraying unit,
the plasma producing unit spraying plasma state gas therein to the object to be bonded from an opening at a tip end thereof, and
the seal gas spraying unit spraying a seal gas from an opening at a tip end of an annular channel provided outside of the plasma producing unit concentrically, thereby sealing the plasma state gas from an ambient air.

2. A bonding apparatus comprising:
a bonding process unit capable of performing a bonding process to an object to be bonded using a bonding arm having a bonding capillary;
a plasma capillary that includes a plasma producing unit and a seal gas spraying unit,
the plasma producing unit spraying plasma state gas therein to the object to be bonded from an opening at a tip end thereof, and
the seal gas spraying unit spraying a seal gas from an opening at a tip end of an annular channel provided outside of the plasma producing unit concentrically, thereby sealing the plasma state gas from an ambient air;
a plasma treatment unit capable of performing surface treatment to the object to be bonded using a plasma arm having a plasma capillary at a tip end of the plasma arm; and
a control unit capable of controlling operations of the bonding arm and the plasma arm in conjunction with each other.

3. The bonding apparatus according to claim 2, wherein
the bonding process unit performs the bonding process to the object to be bonded that is held by a stage for bonding,
the plasma treatment unit performs surface treatment to a different object to be bonded that is held by a stage for surface treatment, the different object to be bonded being the same type as the object to be bonded and subject to the bonding process by the bonding process unit, and
the control unit controls to cause the bonding process and the surface treatment to be performed, in conjunction with each other, to corresponding portions of the same type of the objects to be bonded, respectively.

4. The bonding apparatus according to claim 1, wherein
the plasma producing unit is a capacitatively coupled microplasma producing unit capable of, by power supply to a cylindrical external electrode provided concentrically with a tubular member made of an insulating body and to a linear internal electrode provided along a central axis of the tubular member, spraying the plasma state gas inside the tubular member from an opening at a tip end portion of the tubular member.

5. The bonding apparatus according to claim 2, wherein
the plasma producing unit is a capacitatively coupled microplasma producing unit capable of, by power supply to a cylindrical external electrode provided concentrically with a tubular member made of an insulating body and to a linear internal electrode provided along a central axis of the tubular member, spraying the plasma state gas inside the tubular member from an opening at a tip end portion of the tubular member.

6. A bonding apparatus comprising:
a bonding process unit capable of performing a bonding process to an object to be bonded using a bonding tool;
a plasma capillary that includes a plasma producing unit and a seal gas spraying unit,
the plasma producing unit spraying plasma state gas therein to the object to be bonded from an opening at a tip end thereof, and
the seal gas spraying unit spraying a seal gas from an opening at a tip end of an annular channel provided outside of the plasma producing unit concentrically, thereby sealing the plasma state gas from an ambient air;
a position change unit capable of switching a position of a tip end of a thin wire between a removal position and a deposition position with respect to a plasma region where the gas is formed into plasma state gas within the plasma producing unit,
the thin wire being made of a predetermined material and inserted in the plasma producing unit,
the removal position being a position at which the tip end of the thin wire is positioned outside the plasma region and a removal process is performed to a surface of the object to be bonded by the plasma state gas, and
the deposition position being a position at which the tip end of the thin wire is positioned inside the plasma region and the material of the thin wire is, along with the plasma state gas, splayed to the object to be bonded and deposited on the surface of the object to be bonded; and
a control unit capable of causing the position change unit to switch the position of the thin wire in the microplasma producing unit to the removal position so that contamination and/or an oxide film is removed from the surface of the object to be bonded, and then causing the position of the thin wire to be switched to the deposition position so that the predetermined material is deposited on the surface of the object to be bonded.

7. A bonding apparatus comprising:
a bonding process unit capable of performing a bonding process to an object to be bonded using a bonding arm having a bonding capillary;
a plasma capillary that includes a plasma producing unit and a seal gas spraying unit,
the plasma producing unit spraying plasma state gas therein to the object to be bonded from an opening at a tip end thereof, and
the seal gas spraying unit spraying a seal gas from an opening at a tip end of an annular channel provided outside of the plasma producing unit concentrically, thereby sealing the plasma state gas from an ambient air;
a plasma treatment unit capable of performing surface treatment to the object to be bonded using a plasma arm having a plasma capillary at a tip end of the plasma arm;
a position change unit capable of switching a position of a tip end of a thin wire between a removal position and a deposition position with respect to a plasma region where the gas is formed into plasma state gas within the plasma producing unit,
the thin wire being made of a predetermined material and inserted in the plasma producing unit,
the removal position being a position at which the tip end of the thin wire is positioned outside the plasma region and a removal process is performed to a surface of the object to be bonded by the plasma state gas, and
the deposition position being a position at which the tip end of the thin wire is positioned inside the plasma region and the material of the thin wire is, along with the plasma state gas, splayed to the object to be bonded to be deposited on the surface of the object to be bonded; and
a control unit capable of controlling operations of the bonding arm and the plasma arm in conjunction with each other,
wherein
the control unit causes
the position change unit to switch the position of the thin wire in the microplasma producing unit to the removal position so that contamination and/or an oxide film is removed from the surface of the object to be bonded, and then causes the position of the thin wire to be switched to the deposition position so that the predetermined material is deposited on the surface of the object to be bonded, and
then the control unit further causes
the bonding process unit to perform the bonding process to a portion at which the predetermined material is deposited.

8. The bonding apparatus according to claim 6, wherein
the bonding process unit performs the bonding process to the object to be bonded that is held by a stage for bonding,
the plasma treatment unit performs surface treatment to a different object to be bonded that is held by a stage for surface treatment, the different object to be bonded being the same type as the object to be bonded and subject to the bonding process by the bonding process unit, and
the control unit controls to cause the bonding process and the surface treatment to be performed, in conjunction with each other, to corresponding portions of the same type of the objects to be bonded, respectively.

9. The bonding apparatus according to claim 2, wherein
the control unit controls so that the bonding process and the surface treatment are performed to the same object to be bonded in conjunction with each other.

10. The bonding apparatus according to claim 6, wherein
the control unit controls so that the bonding process and the surface treatment are performed to the same object to be bonded in conjunction with each other.

11. The bonding apparatus according to claim 8, wherein
the control unit controls so that the bonding arm and the plasma arm are moved integrally.

12. The bonding apparatus according to claim 10, wherein
the control unit controls so that the bonding arm and the plasma arm are moved integrally.

13. The bonding apparatus according to claim 1, wherein
the plasma producing unit is an inductively coupled microplasma producing unit capable of, based on power supply to a high frequency coil that is wound about a tubular member made of an insulating body, spraying the plasma state gas in the tubular member from an opening of a tip end portion of the tubular member.

14. The bonding apparatus according to claim 2, wherein
the plasma producing unit is an inductively coupled microplasma producing unit capable of, based on power supply to a high frequency coil that is wound about a tubular member made of an insulating body, spraying the plasma state gas in the tubular member from an opening of a tip end portion of the tubular member.

15. The bonding apparatus according to claim 5, wherein
the plasma producing unit is an inductively coupled microplasma producing unit capable of, based on power supply to a high frequency coil that is wound about a tubular member made of an insulating body, spraying the plasma state gas in the tubular member from an opening of a tip end portion of the tubular member.

16. The bonding apparatus according to claim 6, wherein
the plasma producing unit is an inductively coupled microplasma producing unit capable of, based on power supply to a high frequency coil that is wound about a tubular member made of an insulating body, spraying the plasma state gas in the tubular member from an opening of a tip end portion of the tubular member.

17. The bonding apparatus according to claim 1, wherein
a chemical activity of the seal gas is equal to or lower than a chemical activity of the gas to be formed into plasma state gas.

18. The bonding apparatus according to claim 2, wherein
a chemical activity of the seal gas is equal to or lower than a chemical activity of the gas to be formed into plasma state gas.

19. The bonding apparatus according to claim 5, wherein
a chemical activity of the seal gas is equal to or lower than a chemical activity of the gas to be formed into plasma state gas.

20. The bonding apparatus according to claim 6, wherein
a chemical activity of the seal gas is equal to or lower than a chemical activity of the gas to be formed into plasma state gas.

21. The bonding apparatus according to claim 11, wherein
the seal gas is an inert gas.
